(19) United States
(12) Patent Application Publication
(10) Pub. No.: US 2004/0265689 A1
(43) Pub. Date: Dec. 30, 2004

(54) Alkaline storage battery

(76) Inventors: Makoto Ochi, Myozai-Gun (JP); Takayuki Yano, Takasaki-Shi (JP); Kousuke Satoguchi, Tokushima-Shi (JP); Teruhiko Imoto, Kaizuka-Shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/606,928

(22) Filed: Jun. 27, 2003

(30) Foreign Application Priority Data
Jun. 28, 2002 (JP) 2002-189984
Mar. 28, 2003 (JP) 2003-090535

(51) Int. Cl. H01M 10/26; H01M 4/32

(52) U.S. Cl. 429/206; 429/223

(57) ABSTRACT

With an alkaline storage battery according to the invention, a coating layer of a cobalt compound is provided on the surface a cathode active material composed mainly of nickel hydroxide, and at least one species of compound selected from the group consisting of a niobium compound, titanium compound, tungsten compound and molybdenum compound is added to the coating layer of the cobalt compound while an alkaline electrolytic solution contains lithium hydroxide, and a lithium hydroxide content is not less than 0.6 mol/L and not more than 1.6 mol/L.

As a result, dissolution of the niobium compound, titanium compound, tungsten compound and molybdenum compound, in the alkaline electrolytic solution, can be inhibited and it becomes possible to maintain an excellent electrically conductive network. Consequently, even if recharge/discharge operations are repeated in a high-temperature atmosphere, it is possible to prevent deterioration of conductivity. Hence, an alkaline storage battery excellent in high-temperature cycle life can be provided.

### FIELD OF THE INVENTION

The present invention relates to an alkaline storage battery such as a nickel-hydrogen battery, nickel-cadmium battery, etc., and in particular, to an alkaline storage battery comprising nickel cathodes (positive electrode) containing a cathode active material composed mainly of nickel hydroxide and an alkaline electrolytic solution.

### BACKGROUND OF THE INVENTION

The range of uses of secondary batteries (storage batteries) has lately become broader, and storage batteries have come to be used in a wide variety of equipment including mobile phones, personal computers, electric tools, motor-operated bicycles, hybrid electric vehicles (HEV), electric vehicles (EV), etc. In particular, alkaline storage batteries such as a nickel-hydrogen battery, nickel-cadmium battery, etc., have been put to use as the power source of equipment requiring high output, such as electric tools, motor-operated bicycles, hybrid electric vehicles (HEV), electric vehicles (EV), etc. In addition, the alkaline storage battery has become more significant because it can be used even in a high-temperature atmosphere.

Accordingly, a demand has since arisen for an alkaline storage battery insusceptible to deterioration in recharge/discharge performance and recharge/discharge efficiency even if recharge/discharge operations are carried out in a high-temperature atmosphere. This is because, for example, when an alkaline storage battery is recharged at high temperature, recharge reaction and oxygen generation reaction compete with each other, so that the energy used to generate oxidation reaction (the recharge reaction) of nickel hydroxide as a cathode active material is also utilized for the oxygen generation reaction as well, thereby resulting in deterioration of recharge efficiency.

Accordingly, in Patent Document 1 (JP, H 8-222213, A) an alkaline storage battery has been proposed wherein a layer of an electrically conductive agent composed of a cobalt metal or cobalt compound is made to form on the surface of cathode active material particles composed mainly of nickel hydroxide while one species of compound selected from the group consisting of a zirconium compound, niobium compound, molybdenum compound, and tungsten compound is introduced into cathodes comprising the cathode active material particles.

If one species of compound selected from the group consisting of the zirconium compound, niobium compound, molybdenum compound, and tungsten compound is introduced into the cathodes as described above, the rate at which the cobalt compound coating the surface of the cathode active material composed mainly of nickel hydroxide is dissolved and precipitated in an alkaline electrolytic solution can decrease and the layer of the cobalt compound can become denser in structure, thereby enabling an excellent electrically conductive network to be maintained in the nickel cathode. Accordingly, the oxygen generating overvoltage becomes higher, so that the oxygen generation reaction can be inhibited, thereby enhancing recharging efficiency.

However, the enhancement of the cycle life of the alkaline storage battery in high temperature, wherein one species of a compound selected from the group consisting of zirconium compound, niobium compound, molybdenum compound, and tungsten compound is introduced into the cathodes comprising the cathode active material provided with a layer of an electrically conductive agent composed of cobalt metal and a cobalt compound is far from satisfactory. This is presumably due to the fact that repeated recharge/discharge operations at high temperature will result in the dissolution of the zirconium compound etc. in the alkaline electrolytic solution, thereby causing damage to the cobalt compound (cobalt hydroxide) in the uppermost surface layer by reducing conductivity.

That is, as a result of the initial recharge operation, the cobalt hydroxide in the uppermost surface layer is transformed into cobalt oxide with a higher degree of conductivity in order to be stabilized. Repeated recharge/discharge operations at high temperature causes the zirconium compound etc. to be dissolved in the alkaline electrolytic solution, and the cobalt oxide to be reduced into cobalt hydroxide thereafter to be thereby dissolved and precipitated in an alkaline aqueous solution (an electrolytic solution). As a result, the conductivity of the nickel cathodes is presumed to gradually deteriorate, leading to deterioration in cycle life.

In addition, at the time of recharge/discharge operations, the temperature in the inner portion of the electrode group increases, so that there occurs a difference in temperature between the inner portion and the outer portion of the electrode group, and in the case of the alkaline storage battery to be used in a high-temperature atmosphere, the temperature in the inner parts of the battery rises to a considerably high level. Consequently, degradation rates of the cathodes disposed in the inner portion of the electrode group differ from those of the cathodes disposed on the outer portion of the electrode group due to a rise in the temperature of the cathodes disposed in the inner portion of the electrode group. The same problem occurs in the above-described alkaline storage battery where one species of a compound selected from the group consisting of zirconium compound, niobium compound, molybdenum compound, and tungsten compound is introduced into the cathodes comprising the cathode active material provided with a layer of an electrically conductive agent composed of cobalt metal and a cobalt compound.

Thus, if the degradation rate of the cathode disposed in the respective inner portion of the electrode group increases during high temperature, the cycle life of the battery as a whole is shortened due to a higher degradation rate of the cathode.

### SUMMARY OF THE INVENTION

The present invention has been developed in order to resolve the problem described as above by providing an alkaline storage battery with an excellent cycle life characteristic at high temperature, capable of preventing conductivity deterioration even if recharge/discharge operations repeatedly take place in a high temperature atmosphere.

In addition, the invention is intended to provide an alkaline storage battery with an excellent cycle life at high temperature, capable of inhibiting degradation of cathodes disposed in the inner portion of the electrode group so as to maintain a balance between the degradation rate of the cathodes disposed in the inner portion of the electrode group and the degradation rate of cathodes disposed on the outer portion of the electrode group even if there occurs a difference in temperature between the inner part and the outer side of the electrode group.

To that end, the first aspect of the invention seeks to provide an alkaline storage battery comprising nickel cathodes and an alkaline electrolytic solution, wherein at least one species of compound selected from the group consisting of a niobium compound, titanium compound, tungsten compound and molybdenum compound is introduced into the nickel cathodes comprising a cathode active material composed mainly of nickel hydroxide, which surface has a coating layer of a cobalt compound, whereas the alkaline electrolytic solution contains lithium hydroxide of not less than 0.6 mol/L and not more than 1.6 mol/L.

If at least one species of a compound selected from the group consisting of niobium compound, titanium compound, tungsten compound, and molybdenum compound is introduced into the nickel cathodes as described above, the rate at which the cobalt compound coating the surface of an active material layer composed mainly of nickel hydroxide is dissolved and precipitated in the alkaline electrolytic solution can be decreased. Further, if the alkaline electrolytic solution contains not less than 0.6 mol/L of lithium hydroxide, dissolution of the niobium compound, titanium compound, tungsten compound, and molybdenum compound therein can be inhibited and the layer of the cobalt compound becomes denser in structure, thereby enabling an excellent electrically conductive network to be maintained in the nickel cathodes. However, if the alkaline electrolytic solution contains 1.8 mol/L of lithium hydroxide, the lithium hydroxide is not easily dissolved so that it is necessary to restrict the lithium hydroxide content of the alkaline electrolytic solution to not more than 1.6 mol/L.

In this case, if the layer of the cobalt compound contains alkaline cations, the conductivity of the layer of the cobalt compound is further enhanced, so that the layer of the cobalt compound is preferably a layer of a cobalt compound containing alkaline cations. Further, it has been determined that the rate at which the cobalt compound coating the surface of the active material layer is dissolved and precipitated in the alkaline electrolytic solution is not effectively reduced if the amount of any compound, selected from the group consisting of niobium compound, titanium compound, tungsten compound, and molybdenum compound, added into the nickel cathodes together with the cathode active material, is less than 0.2% by mass in relation to the mass of the cathode active material.

Further, if the amount of compound added is increased to more than 1.0% by mass in relation to the mass of the cathode active material, the amount of nickel hydroxide serving as an active material in the nickel cathodes is reduced thereby decreasing discharge capacity. Accordingly, the amount of niobium compound, titanium compound, tungsten compound, or molybdenum compound to be added should preferably be within the range of 0.2 to 1.0% by mass in relation to the mass of the cathode active material.

In case a niobium compound is used, it must preferably be made of a compound selected from the group consisting of Nb₂O₅, Nb₂O₃, NbO, NbO₂, NaNbO₃, LiNbO₃, KNbO₃, Nb₂O₅.x H₂O, and so forth. In case a titanium compound is used, it must preferably be made of a compound selected from the group consisting of TiO₂, Ti₂O₃, TiO, Na₂Ti₃O₇, Li₂TiO₃, K₂TiO₃ and so forth. Further, in case a tungsten compound is used, it must preferably be made of a compound selected from the group consisting of WO₂, WO₃, Na₂WO₄, Li₂WO₂, K₂WO₄ and so forth. Further still, in case a molybdenum compound is used, it must preferably be made of a compound selected from the group consisting of MoO₃, MoO₃.H₂O, MoO₃.2H₂O, Na₂MoO₄.2H₂O, Li₆Mo₇O₂₄.12H₂O, K₂MoO₄ and so forth.

The second aspect of the invention intends to provide an alkaline storage battery incorporating an electrode group comprising nickel cathodes and anodes (negative electrode), disposed in such a way as to oppose each other with a separator interposed therebetween, wherein each of the nickel cathodes includes a cathode active material composed mainly of nickel hydroxide, having a coating layer of a cobalt compound, and is added with at least one species of a compound selected from the group consisting of niobium compound, titanium compound, tungsten compound and molybdenum compound while the amount of at least one species of a compound selected from the group consisting of niobium compound, titanium compound, tungsten compound and molybdenum compound to be added to each of the nickel cathodes disposed in the inner portion of the electrode group is greater than that for each of the nickel cathodes disposed on the outer portion of the electrode group.

If at least one species of a compound selected from the group consisting of niobium compound, titanium compound, tungsten compound, and molybdenum compound is introduced into the nickel cathodes as described above, the rate at which the cobalt compound coating the surface of an active material layer and composed mainly of nickel hydroxide is dissolved and precipitated in the alkaline electrolytic solution can be reduced and therefore maintenance of an excellent electrically conductive network in the nickel cathodes would be possible. In this case, the nickel cathodes must reside in the respective inner parts of the electrode group for greater effectivity. Thus, it becomes possible to maintain a balance between the degradation rate of the cathodes disposed in the inner portion of the electrode group and the degradation rate of the cathodes disposed on the outer portion of the electrode group even if there occurs a difference in temperature between the inner portion and the outer portion of the electrode group, thereby providing an alkaline storage battery with an excellent cycle life at high temperature.

Further, it has been found that increasing the amount of at least one species of a compound selected from the group consisting of niobium compound, titanium compound, tungsten compound, and molybdenum compound, added to the cathode disposed on the respective outer portion of the electrode group has an adverse effect on the cycle life of the alkaline storage battery at high temperature and therefore needs to be controlled.

On the one hand, if the amount of at least one species of a compound selected from the group consisting of niobium compound, titanium compound, tungsten compound, and molybdenum compound, added to the cathode disposed in the respective inner parts of the electrode group is insufficient, there is no advantageous effect by way of improving the cycle life of the battery at high temperature. Accordingly, the amount of at least one species of a compound selected from the group consisting of niobium compound, titanium compound, tungsten compound, and molybdenum compound, to be added to the cathode disposed in the respective inner portion of the electrode group should preferably be not less than 0.2% by mass.

On the other hand, if the amount of at least one species of a compound selected from the group consisting of niobium compound, titanium compound, tungsten compound, and molybdenum compound, to be added to the cathode disposed in the respective inner portions of the electrode group is excessively increased, the high rate discharge characteristic of the battery at room temperature deteriorates. Accordingly, the amount of at least one species of a compound selected from the group consisting of niobium compound, titanium compound, tungsten compound, and molybdenum compound, to be added to the cathode disposed in the respective inner portions of the electrode group, should preferably correspond to the minimum required amount for maintaining a satisfactory life cycle, that is, not more than 1.0% by mass. In such a case, the conductivity of the layer of the cobalt compound would be further enhanced if it contains alkaline cations.

The third aspect of the invention aims to provide an alkaline storage battery incorporating an electrode group comprising nickel cathodes and anodes, disposed in such a way as to oppose each other with a separator interposed therebetween, and an alkaline electrolytic solution, wherein each of the nickel cathodes includes a cathode active material composed mainly of nickel hydroxide, having a coating layer of a cobalt compound, and are added with at least one species of a compound selected from the group consisting of niobium compound, titanium compound, tungsten compound and molybdenum compound while the amount of at least one species of a compound selected from the group consisting of niobium compound, titanium compound, tungsten compound and molybdenum compound to be added to each of the nickel cathodes disposed in the inner portion of the electrode group is greater than that for each of the nickel cathodes disposed on the outer portion of the electrode group, while the alkaline electrolytic solution contains lithium hydroxide of not less than 0.6 mol/L and not more than 1.6 mol/L.

If the alkaline electrolytic solution contains not less than 0.6 mol/L of lithium hydroxide, dissolution of the niobium compound, titanium compound, tungsten compound and molybdenum compound therein can be inhibited and preserving the state in which the amount of at least one species of a compound selected from the group consisting of niobium compound, titanium compound, tungsten compound and molybdenum compound, to be added to each of the nickel cathodes disposed in the inner portion of the electrode group, is greater than that for each of the nickel cathodes disposed on the outer portion of the electrode group on a longer term basis is significantly improved. Hence, an alkaline storage battery with an excellent cycle life at high temeperature can be provided.

Embodiments of the invention are described in detail hereinafter with reference to FIGS. 1 and 2. However, it is posited that the invention is not limited thereto, and various changes and modifications as appropriate may be made without departing from the spirit and scope of the invention.

### BRIEF DESCRIPTION OF THE DRAWINGS

FIG. 1 is a graph showing the relationship between lithium hydroxide content in an alkaline electrolytic solution, and the capacity maintaining ratio (cycle), in the case of a niobium compound, titanium compound, tungsten compound and molybdenum compound, respectively.

FIG. 2 is a schematic section view of an alkaline storage battery according to the invention.

### PREFERRED EMBODIMENT OF THE INVENTION

1. Fabrication of Nickel Cathode Plates

While stirring an aqueous solution composed of a mixture of nickel sulfate, zinc sulfate, and cobalt sulfate, containing 3 parts by mass of zinc and 1 part by mass of cobalt against 100 parts by mass of nickel metal, respectively, an aqueous solution of sodium hydroxide was gradually added thereto and the pH of the reaction solution was maintained within the range of 13 and 14, thereby causing nickel hydroxide in grain form to be precipitated. An aqueous solution of cobalt sulfate was further added to the solution wherein the nickel hydroxide in grain form was precipitated, and the pH of the reaction solution being maintained at a range of 9 to 10, while spherical hydroxide particles composed mainly of nickel hydroxide were used as nuclei of crystals, thereby causing cobalt hydroxide to be precipitated around the respective nuclei.

Thus, nickel hydroxide particles with a coating layer of cobalt hydroxide on the surface were obtained. Thereafter, alkaline heat treatment was applied to the nickel hydroxide particles, whereby an alkaline solution was sprayed thereto in a hot air flow. During the alkaline heat treatment, temperature was adjusted such that the temperature of the nickel hydroxide particles was kept at 60° C., and 35% by mass of an alkaline solution (aqueous solution of sodium hydroxide), equivalent to 5 times as much as the parts by mass of cobalt, were sprayed. Subsequently, temperature was raised until the temperature of the nickel hydroxide particles reached 90° C. Then, the nickel hydroxide particles were washed and dried at 60° C. and thereafter turned into cathode active material. In so doing, nickel hydroxide powders (the cathode active material) with a highly conductive coating of a cobalt compound containing sodium (alkaline cations), formed on the surface of the nickel hydroxide particles, were obtained.

Subsequently, after making the mixture by adding Nb₂O₅ as a niobium compound to the cathode active material prepared in the above described manner, 200 g of a dispersion liquid containing 0.25% by mass of HPC (hydroxylpropyl cellulose) were added to and mixed with 500 g of the mixture, thereby producing an active material slurry. Depending on the mass of Nb₂O₅ in terms of percentage in relation to the mass of the cathode active material when Nb₂O₅ was added, the active material slurry produced has been was variously designated as follows:

(1) an active material slurry a1: wherein 0.1% by mass of Nb₂O₅ was added

(2) an active material slurry a2: wherein 0.2% by mass of Nb₂O₅ was added

(3) an active material slurry a3: wherein 0.3% by mass of Nb₂O₅ was added

(4) an active material slurry a4: wherein 0.5% by mass of Nb₂O₅ was added

(5) an active material slurry a5: wherein 0.7% by mass of Nb₂O₅ was added

(6) an active material slurry a6: wherein 1.0% by mass of Nb₂O₅ was added

(7) an active material slurry a7: wherein 1.5% by mass of Nb₂O₅ was added

(8) an active material slurry ax: wherein Nb₂O₅ was not added.

In case a niobium compound is used, the compound may be selected from the group consisting of Nb₂O₃, NbO, NbO₂, NaNbO₃, LiNbO₃, KNbO₃, and Nb₂O₅.x H₂O, besides Nb₂O₅.

Thereafter, the active material slurries a1, a3 through a7, and ax were respectively filled in corresponding electrode base plates made of porous nickel 1.7 mm thick so as to reach a predetermined packing density. Subsequently, the respective electrode base plates were dried and rolled to a thickness of 0.75 mm, then cut to a predetermined size, thereby preparing nickel cathodes, respectively, (A1 through A6, and Ax), as follows:

(1) nickel cathode A1: wherein the active material slurry a1 was used;

(2) nickel cathode A2: wherein the active material slurry a3 was used;

(3) nickel cathode A3: wherein the active material slurry a4 was used;

(4) nickel cathode A4: wherein the active material slurry a5 was used;

(5) nickel cathode A5: wherein the active material slurry a6 was used;

(6) nickel cathode A6: wherein the active material slurry a7 was used; and

(7) nickel cathode Ax: wherein the active material slurry ax was used;

Further, the active material slurries a1, a2, a4 and ax were respectively filled in corresponding electrode base plates made of porous nickel 1.7 mm thick so as to reach a predetermined packing density. Subsequently, the respective electrode base plates were dried and rolled to a thickness of 0.95 mm after dried, then cut to a predetermined size, thereby preparing nickel cathodes (B1 through B3, and Bx), respectively, as follows:

(1) nickel cathode B1: wherein the active material slurry a1 was used;

(2) nickel cathode B2: wherein the active material slurry a2 was used;

(3) nickel cathode B3: wherein the active material slurry a4 was used; and

(4) nickel cathode Bx: wherein the active material slurry ax was used.

2. Fabrication of Hydrogen Storage Alloy Anodes

After mixing mesh metal (Mm), nickel (Ni: purity 99.9%), cobalt (Co), Manganese (Mn), and aluminum (Al) together at a predetermined mole ratio, respectively, the mixture obtained was subjected to induction heating in an argon atmosphere inside a high frequency induction furnace to be thereby turned into molten alloy. The molten alloy was thereafter poured into a mold by the publicly known method, and after cooling, an ingot of hydrogen storage alloy expressed by a composition formula MmNiₐCo_{b}Mn_{c}Al_{d} was prepared. The ingot of the hydrogen storage alloy was pulverized through a mechanical crushing method to about 60 μm in average grain size.

Subsequently, hydrogen storage alloy paste was prepared by mixing 20 parts by mass of an aqueous solution of 5% by mass of polyethylene oxide (PEO) as a binder with 100 parts by mass of hydrogen storage alloy powders. The hydrogen storage alloy paste was thereafter applied to both surfaces of a core body made up of punching metal, and dried at room temperature. The workpiece thus obtained was cut to a predetermined size, thereby producing a hydrogen storage alloy anode.

3. Preparation of Alkaline Electrolytic Solution

Various types of alkaline electrolytic solutions were prepared as follows:

(1) By mixing 5.5 mol/L of potassium hydroxide (KOH) with 0.5 mol/L of sodium hydroxide (NaOH), an electrolytic solution e1 was prepared;

(2) By mixing 5.5 mol/L of potassium hydroxide (KOH), 0.5 mol/L of sodium hydroxide (NaOH), and 0.4 mol/L of lithium hydroxide (LiOH) together, an electrolytic solution e2 was prepared;

(3) By mixing 5.5 mol/L of KOH, 0.5 mol/L of NaOH, and 0.6 mol/L of LiOH together, an electrolytic solution e3 was prepared;

(4) By mixing 5.5 mol/L of KOH, 0.5 mol/L of NaOH, and 0.8 mol/L of LiOH together, an electrolytic solution e4 was prepared;

(5) By mixing 5.5 mol/L of KOH, 0.5 mol/L of NaOH, and 1.0 mol/L of LiOH together, an electrolytic solution e5 was prepared;

(6) By mixing 5.5 mol/L of KOH, 0.5 mol/L of NaOH, and 1.2 mol/L of LiOH together, an electrolytic solution e6 was prepared;

(7) By mixing 5.5 mol/L of KOH, 0.5 mol/L of NaOH, and 1.4 mol/L of LiOH together, an electrolytic solution e7 was prepared;

(8) By mixing 5.5 mol/L of KOH, 0.5 mol/L of NaOH, and 1.6 mol/L of LiOH together, an electrolytic solution e8 was prepared;

(9) By mixing 5.5 mol/L of KOH, 0.5 mol/L of NaOH, and 1.8 mol/L of LiOH together, an electrolytic solution e9 was prepared; and

(10) By mixing 6.6 mol/L of KOH with 0.6 mol/L of NaOH, an electrolytic solution e10 was prepared.

4. Fabrication of Winding Electrode Type Nickel-Hydrogen Batteries

Now, the nickel cathode A3 (with the addition of 0.5% by mass of Nb₂O₅) and the nickel cathode Ax (without addition of Nb₂O₅), respectively prepared in the above described manner, together with the hydrogen storage alloy anode, with a separator made of polyproylene-nonwoven fabric, interposed therebetween, were wound about in a spiral form, thereby creating a electrode group for respective batteries to be fabricated. Subsequently, after inserting the electrode groups into corresponding outer cases, respectively, an anode lead extending from an anode of the respective electrode groups was connected to each outer case while a cathode lead extending from a cathode was connected to each cathode lid provided on a sealing body. Thereafter, the electrolytic solutions e1 through e10, prepared in the above described manner, were poured into each outer case, respectively, and the opening of each outer case was sealed with each sealing body, thereby fabricating nickel-hydrogen batteries with nominal capacity 1000 mAh, C1 through C10 and Cx1, respectively, as follows:

(1) battery C1: wherein the nickel cathode A3 and the electrolytic solution e1 were used;

(2) battery C2: wherein the nickel cathode A3 and the electrolytic solution e2 were used;

(3) battery C3: wherein the nickel cathode A3 and the electrolytic solution e3 were used;

(4) battery C4: wherein the nickel cathode A3 and the electrolytic solution e4 were used;

(5) battery C5: wherein the nickel cathode A3 and the electrolytic solution e5 were used;

(6) battery C6: wherein the nickel cathode A3 and the electrolytic solution e6 were used;

(7) battery C7: wherein the nickel cathode A3 and the electrolytic solution e7 were used;

(8) battery C8: wherein the nickel cathode A3 and the electrolytic solution e8 were used;

(9) battery C9: wherein the nickel cathode A3 and the electrolytic solution e9 were used;

(10) battery C10: wherein the nickel cathode A3 and the electrolytic solution e10 were used; and

(11) battery Cx1: wherein the nickel cathode Ax and the electrolytic solution e1 were used.

(Test 1)

The respective batteries C1 through C10 and Cx1, fabricated in the manner described above, the respective batteries were recharged with recharge current at 100 mA (0.1 ItmA) at a temperature of 25° C. for 16 hours, and subsequently discharged with discharge current at 1000 mA (1 ItmA) until each battery reached a voltage of 1.0V and acquired an initial discharge capacity (mAh) from discharge time. The test results obtained are shown in Table 1 below.

Further, the respective batteries C1 through C10 and Cx1 fabricated in the manner described above were recharged with recharge current at 100 mA (0.1 ItmA) at a temperature of 60° C. for 16 hours, and subsequently discharged with discharge current at 500 mA (0.5 ItmA) until each battery reached a voltage of 1.0V, which was defined as one cycle. Thereafter, recharge/discharge cycle tests were repeatedly conducted until the discharge capacity of each battery at 60° C. was reduced to not more than 80% of its discharge capacity determined at the end of the first cycle, which was defined as capacity maintaining ratio (cycle). The test results obtained are shown in Table 1 below.

TABLE 1

| | nickel | | electrolytic solution | | initial | capacity |
|---|---|---|---|---|---|---|
| | Cathode | | composition (mol/L) | | discharge | maintaining |
| battery type | Type | Nb₂O₅ | type | KOH:NaOH:LiOH | capacity (mAh) | ratio (cycle) |
| C1 | A3 | 0.5 | e1 | 5.5:0.5:0.0 | 870 | 290 |
| C2 | A3 | 0.5 | e2 | 5.5:0.5:0.4 | 867 | 300 |
| C3 | A3 | 0.5 | e3 | 5.5:0.5:0.6 | 866 | 380 |
| C4 | A3 | 0.5 | e4 | 5.5:0.5:0.8 | 864 | 385 |
| C5 | A3 | 0.5 | e5 | 5.5:0.5:1.0 | 866 | 385 |
| C6 | A3 | 0.5 | e6 | 5.5:0.5:1.2 | 860 | 445 |
| C7 | A3 | 0.5 | e7 | 5.5:0.5:1.4 | 861 | 450 |
| C8 | A3 | 0.5 | e8 | 5.5:0.5:1.6 | 860 | 445 |
| C9 | A3 | 0.5 | e9 | 5.5:0.5:1.8 | 860 | 440 |
| C10 | A3 | 0.5 | e10 | 6.6:0.6:0.0 | 866 | 305 |
| Cx1 | Ax | 0.0 | e1 | 5.5:0.5:0.0 | 875 | 100 |

As is evident from Table 1 above, the batteries C1 through C10 using the nickel cathode A3 with addition of 0.5% by mass of Nb₂O₅ (niobium compound), have a higher capacity maintaining ratio (high-temperature cycle characteristic) compared to that of the battery Cx1 using the nickel cathode Ax without addition of Nb₂O₅, which has a capacity maintaining ratio of as low as 100.

This is because if recharge/discharge operations are carried out in a high-temperature atmosphere without addition of Nb₂O₅, cobalt oxyhydroxide (CoOOH) resulting from oxidation of cobalt metal and cobalt compound is reduced to cobalt hydroxide {Co(OH)₂} to be thereby dissolved into an alkaline electrolytic solution, so the electrically conductive network is susceptible to breakdown, resulting in deterioration of the capacity maintaining ratio.

On the other hand, if Nb₂O₅ is added, reduction of a cobalt oxide containing sodium to cobalt hydroxide to be thereby dissolved in an alkaline electrolytic solution is inhibited at the time of discharge even if recharge/discharge operations are carried out in a high-temperature atmosphere, so that the electrically conductive network is deemed maintained, resulting in enhancement of the capacity maintaining ratio.

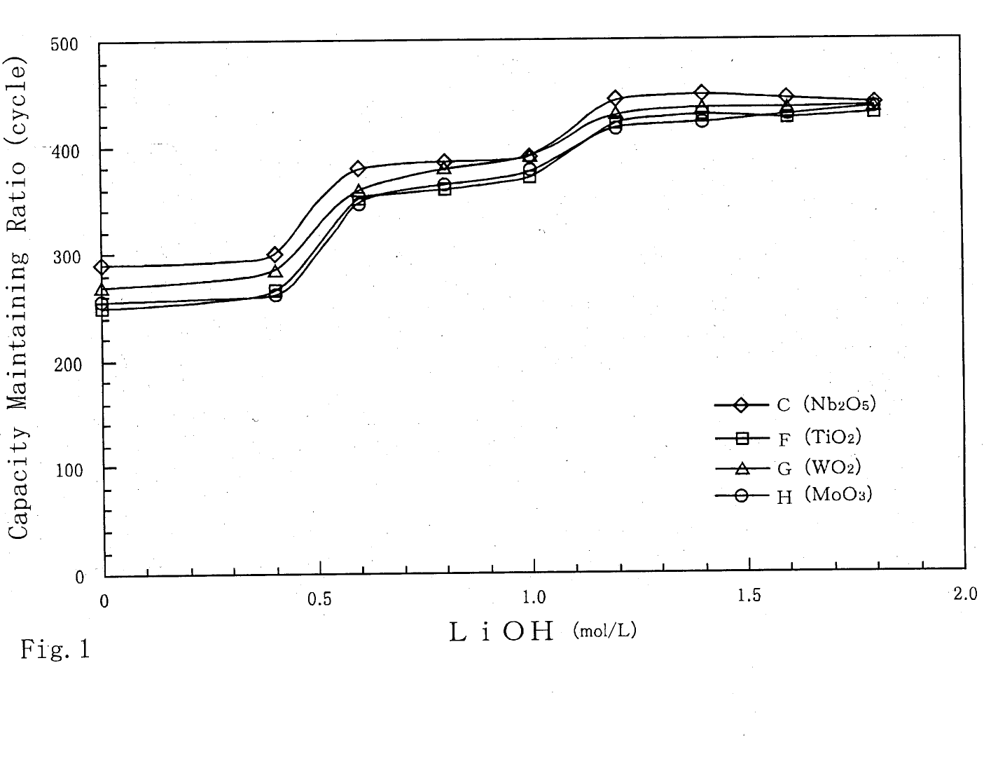

Further, even if Nb₂O₅ were added but the alkaline electrolytic solution does not contain lithium hydroxide (the batteries C1, C10), the capacity maintaining ratio would be 290 and 305, respectively, and if the lithium hydroxide content is low (the battery C2), the capacity maintaining ratio would be 300. Meanwhile, the capacity maintaining ratio is enhanced if the alkaline electrolytic solution contains not less than 0.6 mol/L of lithium hydroxide (the batteries C3 through C9). In this connection, by plotting such a relationship on a graph where lithium hydroxide content (mol/L) in the alkaline electrolytic solution is plotted on the horizontal axis and the capacity maintaining ratio (cycle) is plotted on the vertical axis, a curve denoted by the sign C (symbol ⋄) in FIG. 1 is obtained.

As can be seen in FIG. 1, the amount of lithium hydroxide that the alkaline electrolytic solution should preferably be not less than 0.6 mol/L and not more than 1.6 mol/L, or preferably within the range of 1.2 to 1.6 mol/L. This is because if the alkaline electrolytic solution contains not less than 0.6 mol/L of lithium hydroxide, dissolution of the niobium compound therein would be inhibited and if the solution contains not less than 1.2 mol/L of lithium hydroxide dissolution of the niobium compound in the alkaline electrolytic solution would be inhibited further. In the case of battery A9 involving 1.8 mol/L of lithium hydroxide, however, the lithium hydroxide is not easily dissolved in the alkaline electrolytic solution although the capacity maintaining ratio was found to be high, so that lithium hydroxide content should be limited to not more than 1.6 mol/L.

Furthermore, as in the case of lithium hydroxide, sodium hydroxide has the effect of inhibiting dissolution of Nb₂O₅ (niobium compound) in the alkaline electrolytic solution. However, it is presumed that if sodium hydroxide content is increased, a compound would form from the niobium compound and sodium hydroxide on the surface of a nickel cathode and cause the liquid containing ratio of the nickel cathode to increase, thereby causing the nickel cathode to puff up. Because puffing up of the nickel cathode would lead to an increase in internal resistance of the battery, it is preferable not to increase the sodium hydroxide content.

5. Effect of Increasing the Amount of Niobium Compound (Nb₂O₅) Added

Thereafter, the effect of increasing the amount of Nb₂O₅ (niobium compound) was studied. Now, using the nickel cathodes A1 through A6, Ax and the hydrogen storage alloy anode, prepared in the above described manner, respectively, together with the electrolytic solution e7 (the electrolytic solution prepared by mixing 5.5 mol/L of KOH, 0.5 mol/L of NaOH, and 1.4 mol/L of LiOH together), nickel-hydrogen batteries with nominal capacity of 1000 mAh, C11 through C16 and Cx2, respectively, are fabricated in the same way as previously described, and identified as follows:

(1) the battery C11: wherein the nickel cathode A1 was used;

(2) the battery C12: wherein the nickel cathode A2 was used;

(3) the battery C13: wherein the nickel cathode A3 was used;

(4) the battery C14: wherein the nickel cathode A4 was used;

(5) the battery C15: wherein the nickel cathode A5 was used;

(6) the battery C16: wherein the nickel cathode A6 was used;

(7) the battery Cx2: wherein the nickel cathode Ax was used;

(Test 2)

The respective batteries C11 through C16 and Cx2, fabricated in the manner described above, were recharged with recharge current at 100 mA (0.1 ItmA) at 25° C. for 16 hours, and subsequently discharged with discharge current at 1000 mA (1 ItmA) until each battery reached a voltage of 1.0V, which was defined as one cycle and thereafter, recharge/discharge cycle tests were repeatedly conducted. Further, the respective batteries C11 through C16 and Cx2, were recharged with recharge current at 100 mA (0.1 ItmA) at 60° C. for 16 hours, and subsequently discharged with discharge current at 500 mA (0.5 ItmA) until each battery reached a voltage of 1.0V, which was defined as one cycle and thereafter, recharge/discharge cycle tests were repeatedly conducted until the discharge capacity of each battery at 60° C. was reduced to not more than 80% of its discharge capacity determined at the end of the first cycle, which was defined as the capacity maintaining ratio (cycle). The test results obtained are shown in Table 2 below.

As is evident from Table 2 shown below, as in the case of the battery Cx2 without the addition of Nb₂O₅ (niobium compound), the capacity maintaining ratio (high-temperature cycle characteristic) is low. Further as in the case of the battery C11, if the amount of Nb₂O₅ added is as little as 0.1% by mass in relation to the mass of the cathode active material, there is no improvement in the capacity maintaining ratio (high-temperature cycle characteristic). Further, still, as in the case of the battery C16, if the amount of Nb₂O₅ added is increased to 1.5% by mass in relation to the mass of the cathode active material, the initial discharge capacity will decrease. It may thus be concluded that the amount of Nb₂O₅ (niobium compound) to be added should preferably be within the range of 0.2 to 1.0% by mass in relation to the mass of the cathode active material (composed mainly of nickel hydroxide coated with a cobalt compound). In this connection, the niobium compound to be added to the cathode active material may be made of a compound selected from the group consisting of Nb₂O₃, NbO, NbO₂, NaNbO₃, LiNbO₃, KNbO₃, Nb₂O₅.x H₂O, and so forth, besides Nb₂O₅.

TABLE 2

| | nickel | | electrolytic solution | | Initial | capacity |
|---|---|---|---|---|---|---|
| | Cathode | | composition (mol/L) | | discharge | maintaining |
| battery type | Type | Nb₂O₅ | type | KOH:NaOH:LiOH | capacity (mAh) | ratio (cycle) |
| C11 | A1 | 0.1 | e7 | 5.5:0.5:1.4 | 874 | 250 |
| C12 | A2 | 0.2 | e7 | 5.5:0.5:1.4 | 872 | 440 |
| C13 | A3 | 0.5 | e7 | 5.5:0.5:1.4 | 866 | 450 |
| C14 | A4 | 0.7 | e7 | 5.5:0.5:1.4 | 862 | 440 |
| C15 | A5 | 1.0 | e7 | 5.5:0.5:1.4 | 860 | 445 |
| C16 | A6 | 1.5 | e7 | 5.5:0.5:1.4 | 824 | 430 |
| Cx2 | Ax | 0.0 | e7 | 5.5:0.5:1.4 | 874 | 110 |

6. Studies on Compounds Added

Studies have also been made of cases involving the addition of a titanium compound (for example, TiO₂), tungsten compound (for example, WO₂), and molybdenum compound (for example, MoO₃) to the cathode active material.

(1) Titanium Compound

After preparing an active material slurry by adding TiO₂ as a titanium compound to the cathode active material (composed mainly of nickel hydroxide coated with a cobalt compound) such that the amount of TiO₂ to be added corresponds to 0.5% by mass in relation to the mass of the cathode active material, the active material slurry was poured into an electrode base plate made of porous nickel as previously described. Subsequently, the electrode base plate was dried and rolled then cut to a predetermined size, thereby preparing a nickel cathode F.

Thereafter, the nickel cathode F, and the hydrogen storage alloy anode prepared as previously described, with a separator made of polyproylene-nonwoven fabric, interposed therebetween, were wound about in a spiral form, thereby creating electrode groups for respective batteries to be fabricated. Subsequently, after inserting each electrode group into corresponding outer cases, an anode lead extending from an anode of each respective electrode group was connected to each outer case while a cathode lead extending from a cathode was connected with a cathode lid provided on a sealing body. Thereafter, the electrolytic solutions e1 through e10, prepared as previously described, were poured into the outer cases, respectively, and the opening of each outer case was sealed with the sealing body, thereby fabricating nickel-hydrogen batteries with a nominal capacity of 1000 mAh, F1 through F10 and Cx1, respectively designated, as follows:

(1) the battery F1: wherein the electrolytic solution e1 was used;

(2) the battery F2: wherein the electrolytic solution e2 was used;

(3) the battery F3: wherein the electrolytic solution e3 was used;

(4) the battery F4: wherein the electrolytic solution e4 was used;

(5) the battery F5: wherein the electrolytic solution e5 was used;

(6) the battery F6: wherein the electrolytic solution e6 was used;

(7) the battery F7: wherein the electrolytic solution e7 was used;

(8) the battery F8: wherein the electrolytic solution e8 was used;

(9) the battery F9: wherein the electrolytic solution e9 was used;

(10) the battery F10: wherein the electrolytic solution e10 was used.

(Test 3)

Thereafter, the respective batteries F1 through F10, fabricated in the manner described above, were recharged with recharge current at 100 mA (0.1 ItmA) at 25° C. for 16 hours, and subsequently discharged with discharge current at 1000 mA (1 ItmA) until each battery reached a voltage of 1.0V and acquired an initial discharge capacity from discharge time. The test results obtained are shown in Table 3 below.

Further, the respective batteries F1 through F10, were recharged with recharge current at 100 mA (0.1 ItmA) at 60° C. for 16 hours, and subsequently discharged with discharge current at 500 mA (0.5 ItmA) until each battery reached a voltage of 1.0V, which was defined as one cycle. Thereafter, recharge/discharge cycle tests were repeatedly conducted until the discharge capacity of each battery at 60° C. was reduced to not more than 80% of its discharge capacity determined at the end of the first cycle, which was defined as capacity maintaining ratio (cycle). The test results obtained as well as the results concerning the batteries Cx1 and Cx2 are shown in Table 3 below.

TABLE 3

| | nickel | | electrolytic solution | | Initial | capacity |
|---|---|---|---|---|---|---|
| | cathode | | composition (mol/L) | | discharge | maintaining |
| battery type | Type | TiO₂ | type | KOH:NaOH:LiOH | capacity (mAh) | ratio (cycle) |
| F1 | F | 0.5 | e1 | 5.5:0.5:0.0 | 868 | 250 |
| F2 | F | 0.5 | e2 | 5.5:0.5:0.4 | 866 | 265 |
| F3 | F | 0.5 | e3 | 5.5:0.5:0.6 | 864 | 355 |
| F4 | F | 0.5 | e4 | 5.5:0.5:0.8 | 863 | 360 |
| F5 | F | 0.5 | e5 | 5.5:0.5:1.0 | 865 | 370 |
| F6 | F | 0.5 | e6 | 5.5:0.5:1.2 | 861 | 425 |
| F7 | F | 0.5 | e7 | 5.5:0.5:1.4 | 860 | 430 |
| F8 | F | 0.5 | e8 | 5.5:0.5:1.6 | 861 | 425 |
| F9 | F | 0.5 | e9 | 5.5:0.5:1.8 | 859 | 430 |
| F10 | F | 0.5 | e10 | 6.6:0.6:0.0 | 865 | 260 |
| Cx2 | F | 0.0 | e7 | 5.5:0.5:1.4 | 874 | 110 |
| Cx1 | F | 0.0 | e1 | 5.5:0.5:0.0 | 875 | 100 |

As is evident from Table 3 above, the batteries F1 through F10 using the nickel cathode F with addition of 0.5% by mass of TiO₂ (titanium compound), have a higher capacity maintaining ratio (high-temperature cycle characteristic) compared with that of the case of the batteries Cx2, Cx1 using the nickel cathode Ax without addition of TiO₂, respectively, whose capacity maintaining ratio is low or within the range of 110 to 100.

This is because if recharge/discharge operations are carried out in a high-temperature atmosphere without addition of TiO₂, cobalt oxyhydroxide (CoOOH) resulting from oxidation of cobalt metal and cobalt compound is reduced to cobalt hydroxide {Co(OH)₂} to be thereby dissolved into an alkaline electrolytic solution, the electrically conductive network is susceptible to breakdown, resulting in deterioration of the capacity maintaining ratio.

On the other hand, if TiO₂ is added, reduction of a cobalt oxide containing sodium to cobalt hydroxide to be thereby dissolved in an alkaline electrolytic solution is inhibited at the time of discharge even if recharge/discharge operations are carried out in a high temperature atmosphere, so that the electrically conductive network is deemed maintained, resulting in enhancement of the capacity maintaining ratio.

Further, even if TiO₂ were added but if alkaline electrolytic solution does not contain lithium hydroxide (the batteries F1, F10), the capacity maintaining ratio would be 250 cycles and 260 cycles, respectively, while if the lithium hydroxide content is low (the battery F2), the capacity maintaining ratio would be 265 cycles. Meanwhile, the capacity maintaining ratio is enhanced if the alkaline electrolytic solution contains not less than 0.6 mol/L of lithium hydroxide (the batteries F3 through F9). In this connection, by plotting such a relationship on a graph where lithium hydroxide content (mol/L) in the alkaline electrolytic solution is plotted on the horizontal axis and the capacity maintaining ratio (cycle) is plotted on the vertical axis, a curve denoted by the sign F (symbol □) is obtained as shown in FIG. 1

As is evident in FIG. 1, the preferable amount of lithium hydroxide in the alkaline electrolytic solution should be not less than 0.6 mol/L and not more than 1.6 mol/L, or preferably within the range of 1.2 to 1.6 mol/L. This is because if the alkaline electrolytic solution contains not less than 0.6 mol/L of lithium hydroxide, dissolution of TiO2 in the alkaline electrolytic solution would be inhibited, and if the solution contains not less than 1.2 mol/L of lithium hydroxide, dissolution of TiO₂ in the alkaline electrolytic solution would be inhibited further. In the case of the battery F9 containing 1.8 mol/L of lithium hydroxide, the lithium hydroxide is not easily dissolved in the alkaline electrolytic solution although the capacity maintaining ratio was found to be high, so that lithium hydroxide content should be limited to not more than 1.6 mol/L.

Furthermore, as in the case of lithium hydroxide, sodium hydroxide has the effect of inhibiting dissolution of TiO₂ (titanium compound) in the alkaline electrolytic solution. However, it is presumed that if sodium hydroxide content is increased, a compound would form from TiO₂ and sodium hydroxide on the surface of a nickel cathode and cause the liquid containing ratio of the nickel cathode to increase, thereby causing the nickel cathode to puff up. Because puffing up of the nickel cathode would effectively increase in internal resistance of the battery, it is preferable not to increase the sodium hydroxide content.

Further, the amount of TiO₂ to be added should preferably be within the range of 0.2 to 1.0% by mass as in the case of the niobium compound as previously described. In this connection, the titanium compound to be added to the cathode active material may be made of any compound selected from the group consisting of Ti₂O₃, TiO, Na₂Ti₃O₇, Li₂TiO₃, K₂TiO₃ and so forth, besides TiO₂.

(2) Tungsten Compounds

After preparing an active material slurry by adding WO₂ as a tungsten compound to the cathode active material (composed mainly of nickel hydroxide coated with a cobalt compound) such that the amount of WO₂ to be added corresponds to 0.5% by mass in relation to the mass of the cathode active material, the active material slurry was poured into an electrode base plate made of porous nickel as previously described. Subsequently, the electrode base plate was dried and rolled, then cut to a predetermined size, thereby preparing a nickel cathode G.

Thereafter, the nickel cathode G and the hydrogen storage alloy anode prepared as previously described, with a separator made of polyproylene-nonwoven fabric, interposed therebetween, were wound about in a spiral form, thereby producing electrode groups for respective batteries to be fabricated. Subsequently, after inserting each respective electrode group into corresponding outer cases, an anode lead extending from an anode of the respective electrode group was connected to each outer case while a cathode lead extending from a cathode was connected to a cathode lid provided on a sealing body. Thereafter, the electrolytic solutions e1 through e10, prepared as previously described, were poured into the outer case, respectively, and the opening of each outer case was sealed with the sealing body, thereby fabricating nickel-hydrogen batteries with a nominal capacity of 1000 mAh, G1 through G10, respectively designated, as follows:

(1) the battery G1: wherein the electrolytic solution e1 was used;

(2) the battery G2: wherein the electrolytic solution e2 was used;

(3) the battery G3: wherein the electrolytic solution e3 was used;

(4) the battery G4: wherein the electrolytic solution e4 was used;

(5) the battery G5: wherein the electrolytic solution e5 was used;

(6) the battery G6: wherein the electrolytic solution e6 was used;

(7) the battery G7: wherein the electrolytic solution e7 was used;

(8) the battery G8: wherein the electrolytic solution e8 was used;

(9) the battery G9: wherein the electrolytic solution e9 was used;

(10) the battery G10: wherein the electrolytic solution e10 was used.

(Test 4)

Thereafter, the respective batteries G1 through G10, fabricated in the manner described above, were recharged with recharge current at 100 mA (0.1 ItmA) at 25° C. for 16 hours, and subsequently discharged with discharge current at 1000 mA (1 ItmA) until each battery reached a voltage of 1.0V and acquired an initial discharge capacity from discharge time. The test results otained are shown in Table 4 below.

Further, the respective batteries G1 through G10 were recharged with recharge current at 100 mA (0.1 ItmA) at 60° C. for 16 hours, and subsequently discharged with discharge current at 500 mA (0.5 ItmA) until each battery reached a voltage of 1.0V, which was defined as one cycle. Thereafter, recharge/discharge cycle tests were repeatedly conducted until the discharge capacity of each battery at 60° C. diminished by not more than 80% of its discharge capacity determined at the end of the first cycle, which was defined as the capacity maintaining ratio (cycle) The test results obtained as well as the results concerning concerning the batteries Cx1 and Cx2, respectively, are shown in Table 4 below.

TABLE 4

| | nickel | | electrolytic solution | | initial | capacity |
|---|---|---|---|---|---|---|
| | cathode | | composition (mol/L) | | discharge | maintaining |
| battery type | Type | WO₂ | type | KOH:NaOH:LiOH | capacity (mAh) | ratio (cycle) |
| G1 | G | 0.5 | e1 | 5.5:0.5:0.0 | 869 | 270 |
| G2 | G | 0.5 | e2 | 5.5:0.5:0.4 | 865 | 285 |
| G3 | G | 0.5 | e3 | 5.5:0.5:0.6 | 863 | 360 |
| G4 | G | 0.5 | e4 | 5.5:0.5:0.8 | 863 | 380 |
| G5 | G | 0.5 | e5 | 5.5:0.5:1.0 | 862 | 390 |
| G6 | G | 0.5 | e6 | 5.5:0.5:1.2 | 861 | 430 |
| G7 | G | 0.5 | e7 | 5.5:0.5:1.4 | 860 | 435 |
| G8 | G | 0.5 | e8 | 5.5:0.5:1.6 | 862 | 435 |
| G9 | G | 0.5 | e9 | 5.5:0.5:1.8 | 858 | 435 |
| G10 | G | 0.5 | e10 | 6.6:0.6:0.0 | 864 | 275 |
| Cx2 | Ax | 0.0 | e7 | 5.5:0.5:1.4 | 874 | 110 |
| Cx1 | Ax | 0.0 | e1 | 5.5:0.5:0.0 | 875 | 100 |

As is evident from Table 4 above, the batteries G1 through G10 using the nickel cathode G with the addition of 0.5% by mass of WO₂(tungsten compound have a higher capacity maintaining ratio (high-temperature cycle characteristic) compared to that of the batteries Cx2, Cx1 using the nickel cathode Ax without addition of WO₂, respectively, whose a capacity maintaining ratio is low or within the range of 110 to 100.

This is because if recharge/discharge operations are carried out in a high-temperature atmosphere without addition of WO₂, cobalt oxyhydroxide (CoOOH), resulting from oxidation of cobalt metal and cobalt compound, is reduced to cobalt hydroxide {Co(OH)₂} to be thereby dissolved in an alkaline electrolytic solution, so that the electrically conductive network is susceptible to breakdown, resulting in deterioration of the capacity maintaining ratio.

On the other hand, if WO₂ is added, reduction of a cobalt oxide containing sodium to cobalt hydroxide to be thereby dissolved into an alkaline electrolytic solution is inhibited at the time of discharge even if recharge/discharge operations are carried out in a high temperature atmosphere, so that the electrically conductive network is deemed maintained, resulting in enhancement of the capacity maintaining ratio.

Further, even if WO₂ were added, but the alkaline electrolytic solution does not contain lithium hydroxide (the batteries G1, G10), the capacity maintaining ratio would be 270 cycles and 275 cycles, respectively, and if the lithium hydroxide content is low (the battery G2), the capacity maintaining ratio would be 285 cycles. Meanwhile, the capacity maintaining ratio is enhanced if the alkaline electrolytic solution contains not less than 0.6 mol/L of lithium hydroxide (the batteries G3 through G9). In this connection, by plotting such a relationship on a graph where lithium hydroxide content (mol/L) of the alkaline electrolytic solution is plotted on the horizontal axis and the capacity maintaining ratio (cycle) is plotted on the vertical axis, a curve denoted by sign G (symbol Δ) is obtained as shown in FIG. 1.

Based on the results shown in FIG. 1, the preferable amount lithium hydroxide that the alkaline electrolytic solution should contain is not less than 0.6 mol/L and not more than 1.6 mol/L, or preferably within the range of 1.2 to 1.6 mol/L. This is because if the alkaline electrolytic solution contains not less than 0.6 mol/L of lithium hydroxide dissolution of WO₂ in the alkaline electrolytic solution would be inhibited, and if the solution contains not less than 1.2 mol/L of lithium hydroxide, dissolution of WO₂ in the alkaline electrolytic solution would be inhibited further. In the case of the battery G9 involving 1.8 mol/L of lithium hydroxide, however, the lithium hydroxide is not easily dissolved in the alkaline electrolytic solution although the capacity maintaining ratio was found to be high, so that lithium hydroxide content should be limited to not more than 1.6 mol/L

Furthermore, as in the case of lithium hydroxide, sodium hydroxide has the effect of inhibiting dissolution of WO₂ (tungsten compound) in the alkaline electrolytic solution. However, it is presumed that if sodium hydroxide content is increased, a compound would form from WO₂ and sodium hydroxide on the surface of a nickel cathode and cause the liquid containing ratio of the nickel cathode to increase, thereby causing the nickel cathode to puff up. Because puffing up of the nickel cathode would effectively increase in internal resistance of the battery, it is preferable not to increase the sodium hydroxide content.

Further, the amount of WO₂ to be added should preferably be within the range of 0.2 to 1.0% by mass as in the case of the niobium compound as previously described. In this connection, the tungsten compound to be added to the cathode active material may be made of any compound selected from the group consisting of WO₃, Na₂WO₄, Li₂WO₂, K₂WO₄ and so forth, besides WO₂.

(3) Molybdenum Compounds

After preparing an active material slurry by adding MoO₃ as a molybdenum compound to the cathode active material (composed mainly of nickel hydroxide coated with a cobalt compound) prepared as previously described such that the amount of MoO₃ to be added corresponds to 0.5% by mass in relation to the mass of the cathode active material, the active material slurry was poured into an electrode base plate made of porous nickel as previously described. Subsequently, the electrode base plate was dried and rolled then cut to a predetermined size, thereby preparing a nickel cathode H.

Thereafter, the nickel cathode H and the hydrogen storage alloy anode prepared as previously described, with a separator made of polyproylene-nonwoven fabric, interposed therebetween, were wound about in a spiral form, thereby forming electrode groups, respectively. Subsequently, after inserting the respective electrode groups into respective outer cases, an anode lead extending from an anode of each respective electrode group was connected to each outer case while a cathode lead extending from a cathode was connected to a cathode lid provided on a sealing body. Thereafter, the electrolytic solutions e1 through e10, prepared as previously described, were poured into the outer cases, respectively, and the opening of each outer case was sealed with the sealing body, thereby fabricating nickel-hydrogen batteries with nominal capacity of 1000 mAh, H1 through H10, respectively, as follows:

(1) the battery H1: wherein the electrolytic solution e1 was used;

(2) the battery H2: wherein the electrolytic solution e2 was used;

(3) the battery H3: wherein the electrolytic solution e3 was used;

(4) the battery H4: wherein the electrolytic solution e4 was used;

(5) the battery H5: wherein the electrolytic solution e5 was used;

(6) the battery H6: wherein the electrolytic solution e6 was used;

(7) the battery H7: wherein the electrolytic solution e7 was used;

(8) the battery H8: wherein the electrolytic solution e8 was used;

(9) the battery H9: wherein the electrolytic solution e9 was used;

(10) the battery H10: wherein the electrolytic solution e10 was used;

(Test 5)

Thereafter, the respective batteries H1 through H10 fabricated in the manner described above were recharged with recharge current at 100 mA (0.1 ItmA) at 25° C. for 16 hours, and subsequently discharged with discharge current at 1000 mA (1 ItmA) until each battery reached a voltage of 1.0V and acquired an initial discharge capacity from discharge time. The test results obtained are shown in Table 5 below.

Further, the batteries H1 through H10 fabricated in the manner described above were recharged with recharge current at 100 mA (0.1 ItmA) at 60° C. for 16 hours, and subsequently discharged with discharge current at 500 mA (0.5 ItmA) until each battery reached a voltage of 1.0V, which was defined as one cycle. Thereafter, recharge/discharge cycle tests were repeatedly conducted until the discharge capacity of each battery at 60° C. was reduced to not more than 80% of its discharge capacity determined at the end of the first cycle, which was defined as capacity maintaining ratio (cycle). The test results obtained as well as the results concerning the batteries Cx1 and Cx2 are shown in Table 5 below.

TABLE 5

| | nickel | | electrolytic solution | | initial | capacity |
|---|---|---|---|---|---|---|
| | cathode | | composition (mol/L) | | discharge | maintaining |
| battery type | Type | Nb₂O₅ | type | KOH:NaOH:LiOH | capacity (mAh) | ratio (cycle) |
| H1 | H | 0.5 | e1 | 5.5:0.5:0.0 | 871 | 255 |
| H2 | H | 0.5 | e2 | 5.5:0.5:0.4 | 868 | 260 |
| H3 | H | 0.5 | e3 | 5.5:0.5:0.6 | 866 | 350 |
| H4 | H | 0.5 | e4 | 5.5:0.5:0.8 | 862 | 365 |
| H5 | H | 0.5 | e5 | 5.5:0.5:1.0 | 864 | 375 |
| H6 | H | 0.5 | e6 | 5.5:0.5:1.2 | 861 | 420 |
| H7 | H | 0.5 | e7 | 5.5:0.5:1.4 | 860 | 425 |
| H8 | H | 0.5 | e8 | 5.5:0.5:1.6 | 862 | 430 |
| H9 | H | 0.5 | e9 | 5.5:0.5:1.8 | 857 | 435 |
| H10 | H | 0.5 | e10 | 6.6:0.6:0.0 | 865 | 260 |
| Cx2 | Ax | 0.0 | e7 | 5.5:0.5:1.4 | 874 | 110 |
| Cx1 | Ax | 0.0 | e1 | 5.5:0.5:0.0 | 875 | 100 |

As is evident from Table 5 above, the batteries H1 through H10 using the nickel cathode H with the addition of 0.5% by mass of MoO₃ (molybdenum compound) have a higher capacity maintaining ratio (high-temperature cycle characteristic) compared to that of the batteries Cx2, Cx1 using the nickel cathode Ax without addition of MoO₃, respectively, whose capacity maintaining ratio is low or within the range of 110 to 100 cycles.

This is because upon recharge/discharge in a high-temperature atmosphere without addition of MoO₃, cobalt oxyhydroxide (CoOOH), resulting from oxidation of cobalt metal and cobalt compound is reduced to cobalt hydroxide {Co(OH)₂} to be thereby dissolved in an alkaline electrolytic solution, so that the electrically conductive network is susceptible to breakdown, resulting in deterioration of the capacity maintaining ratio.

On the other hand, if MoO₃ is added, reduction of a cobalt oxide containing sodium to cobalt hydroxide to be thereby dissolved into an alkaline electrolytic solution is inhibited at the time of discharge even if recharge/discharge operations are carried out in a high temperature atmosphere, so that the electrically conductive network is deemed maintained, resulting in enhancement of the capacity maintaining ratio.

Further, it was determined that even if MoO₃ were added but the alkaline electrolytic solution does not contain lithium hydroxide, the capacity maintaining ratio is low (the batteries H1, H10), would be 255 cycles, and 260 cycles, respectively, while if the lithium hydroxide content is low (the battery H2), the capacity maintaining ratio would be 260 cycles. Meanwhile, the capacity maintaining ratio is enhanced if the alkaline electrolytic solution contains not less than 0.6 mol/L of lithium hydroxide (the batteries H3 through H9). In this connection, by plotting such a relationship on a graph where lithium hydroxide content (mol/L) of the alkaline electrolytic solution is plotted on the horizontal axis and the capacity maintaining ratio (cycle) is plotted on the vertical axis, a curve denoted by sign H (symbol O) is obtained as shown in FIG. 1.

Based on the results shown in FIG. 1, the preferable amount of lithium hydroxide that the alkaline electrolytic solution should contain is not less than 0.6 mol/L and not more than 1.6 mol/L, or preferably within the range of 1.2 to 1.6 mol/L. This is because if the alkaline electrolytic solution contains not less than 0.6 mol/L of lithium hydroxide dissolution of MoO₃ therein would be inhibited, and if the solution contains not less than 1.2 mol/L of lithium hydroxide dissolution of MoO₃ therein would be inhibited further. In the case of the battery H9 involving 1.8 mol/L of lithium hydroxide, however, lithium hydroxide is not easily dissolved in the alkaline electrolytic solution although the capacity maintaining ratio is high, so that lithium hydroxide content should be limited to not more than 1.6 mol/L.

Furthermore, as in the case of lithium hydroxide, sodium hydroxide has the effect of inhibiting dissolution of MoO₃ (molybdenum compound) in the alkaline electrolytic solution. However, it is presumed that if sodium hydroxide content is increased, a compound would form from MoO₃ and sodium hydroxide on the surface of the nickel cathode and cause the liquid containing ratio of the nickel cathode to increase, thereby causing the nickel cathode to puff up. Because puffing up of the nickel cathode would lead to an increase in internal resistance of the battery, it is preferable not to increase the sodium hydroxide content. Further, the amount of MoO₃ (molybdenum compound) to be added should preferably be within the range of 0.2 to 1.0% by mass as in the case of niobium compound (Nb₂O₅) previously described. In this case, the molybdenum compound to be added to the cathode active material may be made of a compound selected from the group consisting of MoO₃.H₂O, MoO₃.2H₂O, Na₂MoO₄.2H₂O, Li₆Mo₇O₂₄.12H₂O, K₂MoO₄ and so forth, besides MoO₃.

Under the examples given above, the fabrication of the batteries comprising the alkaline electrolytic solution containing not less than 0.6 mol/L and not more than 1.6 mol/L of lithium hydroxide, or batteries wherein at least one species of compound selected from the group consisting of a niobium compound, titanium compound, tungsten compound and molybdenum compound is added to the cathode active material composed mainly of nickel hydroxide, having a coating layer of a cobalt compound, and the amount of any of those compounds introduced into the cathode disposed in the respective inner portion of the electrode group is greater than that for the cathode disposed on the respective outer portion of the electrode group has been illustrated.

Now, an alkaline storage battery consisting of the combination of two batteries of the above-described constitutions has been fabricated under the abovementioned conditions and subjected to tests under the same method described above, whereupon it was confirmed to have infinitely better life cycle characteristics at high temperature.

7. Preparation of Flat Plate Electrode Nickel-Hydrogen Batteries

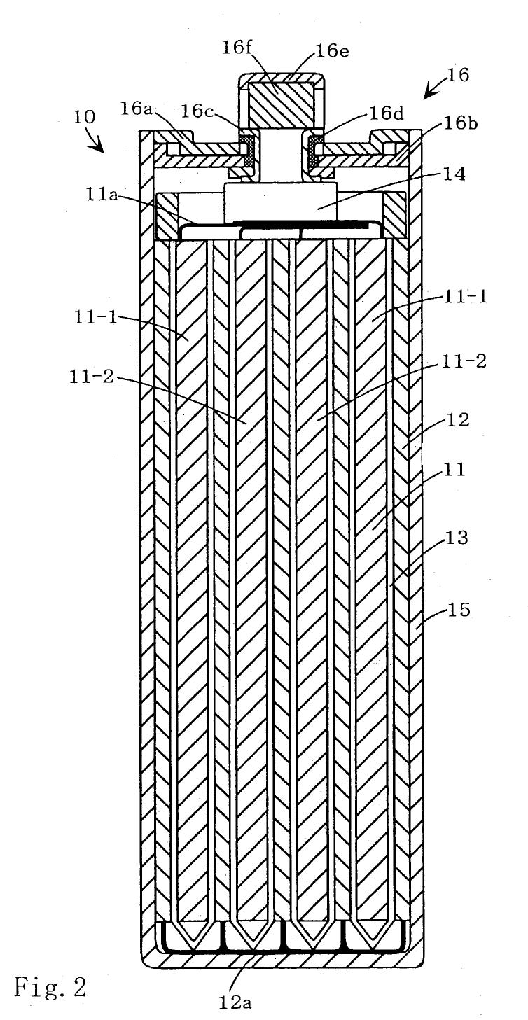

As shown in FIG. 2, using four nickel cathode plates 11 (B1 through B3, Bx), and five hydrogen storage alloy anode plates 12, separately prepared as previously described, with a separator 13 made of nonwoven fabric of polyproylene, interposed therebetween, respectively, the nickel cathode plates 11 were alternately laminated to the hydrogen storage alloy anode plates 12, respectively, in such a way as to oppose each other. Subsequently, cathode conductor tabs 11a disposed on the nickel cathode plates 11, respectively, were welded with each other while anode conductor tabs 12a disposed on the hydrogen storage alloy anode plates 12, respectively, were welded with each other. Subsequently, a cathode current collector 14 was welded to the welded cathode conductor tabs 11a, thereby forming an electrode group. Thereafter, the electrode group was inserted into an outer case 15 in box-like shape, and subsequently, the cathode current collector 14 was welded to the lower end of a cathode terminal member 16c of a sealing body 16. Then, an alkaline electrolytic solution of a predetermined concentration was poured into the outer case 15, and an opening of the outer case 15 was sealed with the sealing body 16, thereby fabricating a nickel-hydrogen battery square in shape with a nominal capacity of 900 mAh.

The sealing body 16 comprises a lid 16a made of metal, substantially rectangular in shape, having an opening in the center thereof; an insulator plate 16b made of a synthetic resin, substantially rectangular in shape, and disposed underneath the lid 16a, having an opening in the center thereof; the cathode terminal member 16c substantially in box-like shape inserted into the openings; a gasket 16d disposed between the lid 16a and the cathode terminal member 16c for insulating the cathode terminal member 16c from the lid 16a while implementing liquid-tightness therebetween; and a cathode cap 16e disposed on top of the cathode terminal member 16c, and welded to the top side thereof.

After replacing the sealing body 16 constructed in the manner described above over an opening of the outer case 15, the periphery of the lid 16a is laser-welded with the inner peripheral face of the upper part of the outer case 15, thereby sealing the outer case 15 so as to be liquid-tight. Furthermore, a valve 16f having elasticity is made to reside inside the cathode cap 16e, so that if gas is emitted inside the battery and pressure therein rises to a level higher than a predetermined pressure, the valve 16f undergoes elastic deformation, thereby enabling the gas emitted inside the battery to be released through a gas vent provided in the cathode cap 16e. Thus, since the valve 16f functions as a safety valve, pressure rise inside the battery can be prevented.

A variety of batteries were fabricated as follows:

(i) battery J1: a battery using an electrode group wherein the cathode plate Bx without the addition of a niobium compound is disposed as a cathode plate 11-1 on respective outer portions (on the sides adjacent to the outer case 15) of the electrode group, and the cathode plate Bx is disposed as a cathode plate 11-2 in respective outer inner parts of the electrode group;

(ii) battery J2: a battery using an electrode group wherein the cathode plate B3 with the addition of 0.5% by mass of a niobium compound is disposed as a cathode plate 11-1 on respective outer portions of the electrode group, and the same cathode plate Bx without the addition of a niobium compound is also disposed as a cathode plate 11-2 in respective outer inner parts of the electrode group;

(iii) battery J3: a battery using an electrode group wherein the cathode plate Bx without addition of a niobium compound is disposed as a cathode plate 11-1 on respective outer portions of the electrode group, and the cathode plate B1 with addition of 0.1% by mass of a niobium compound is disposed as a cathode plate 11-2 in respective inner portions of the electrode group;

(iv) battery J4: a battery using an electrode group wherein the cathode plate Bx without addition of a niobium compound is disposed as a cathode plate 11-1 on respective outer portions of the electrode group, and the cathode plate B2 with addition of 0.2% by mass of a niobium compound is disposed as a cathode plate 11-2 in respective inner portions of the electrode group;

(v) battery J5: a battery using an electrode group wherein the cathode plate Bx without addition of a niobium compound is disposed as a cathode plate 11-1 on respective outer portions of the electrode group, and the cathode plate B3 with addition of 0.5% by mass of a niobium compound is disposed as a cathode plate 11-2 in respective inner portions of the electrode group;

(vi) battery J6: a battery using an electrode group wherein the cathode plate B1 with addition of 0.1% by mass of a niobium compound is disposed as a cathode plate 11-1 on respective outer portions of the electrode group, and the cathode plate B3 with addition of 0.5% by mass of a niobium compound is disposed as a cathode plate 11-2 in respective inner portions of the electrode group;

(vii) battery J 7: a battery using an electrode group wherein the cathode plate B2 with addition of 0.2% by mass of a niobium compound is disposed as a cathode plate 11-1 on respective outer portions of the electrode group, and the cathode plate B3 with addition of 0.5% by mass of a niobium compound is disposed as a cathode plate 11-2 in respective inner portions of the electrode group; and

(viii) battery J8: a battery using an electrode group wherein the cathode plate B3 with addition of 0.5% by mass of a niobium compound is disposed as a cathode plate 11-1 on respective outer portions of the electrode group, and the cathode plate B3 with addition of 0.5% by mass of a niobium compound is also disposed as a cathode plate 11-2 in respective inner portions of the electrode group.

(Test 6)

Thereafter, the batteries J1 through J8, fabricated in the manner described above, were recharged with recharge current at 900 mA (1 ItmA) with ambient air at room temperature (25° C.) until the voltage of each battery (−ΔV), occurring after the cathode is fully charged, had dropped to 10 mV, and after a recess of one hour, 1 It discharge was carried out whereby discharge with discharge current at 900 mA (1 ItmA) was continued until the voltage of each battery reached 1.0V, thereby acquiring a discharge capacity X (mAh) from discharge time.

Subsequently, the respective batteries were recharged with recharge current at 900 mA (1 ItmA) with ambient air at room temperature (25° C.) until the voltage of each battery (−ΔV), occurring after the cathode is fully charged, had become 10 mV, and after a recess of one hour, 4 It high-rate discharge was carried out whereby discharge with discharge current at 3600 mA (4 ItmA) was continued until the voltage of each battery reached 1.0V, thereby thereby acquiring a discharge capacity Y (mAh) from discharge time. Thereafter, the ratio of Y to X [(Y/X) ×100%] was calculated to determine the high-rate discharge characteristic at room temperature. The test results obtained are shown in Table 6 below.

Further, the batteries J1 through J8, fabricated in the manner described above, were recharged with recharge current at 900 mA (1 ItmA) with ambient temperature of 60° C. for 2 hours, and subsequently discharged with discharge current at 460 mA (0.5 ItmA) until the voltage of each battery reached 1.0V, which was defined as one cycle. Thereafer, recharge/discharge cycle tests were repeatedly conducted until the discharge capacity of each battery had been reduced to not more than 80% of its discharge capacity determined at the end of the first cycle at 60° C., which was defined as the high-temperature life cycle. The test results obtained are shown in Table 6 below.

TABLE 6

| | | | | | high rate | high |
|---|---|---|---|---|---|---|
| | nickel cathode | | nickel cathode | | discharge | temp. |
| | (outer) | | (inner) | | at room | life |
| battery | | add. amount | | add. amount | temp. | cycle |
| type | type | (% by mass) | type | (% by mass) | (%) | (times) |
| J1 | Bx | no addition | Bx | no addition | 82 | 100 |
| J2 | B3 | 0.5 | Bx | no addition | 78 | 250 |
| J3 | Bx | no addition | B1 | 0.1 | 80 | 290 |
| J4 | Bx | no addition | B2 | 0.2 | 81 | 400 |
| J5 | Bx | no addition | B3 | 0.5 | 80 | 410 |
| J6 | B1 | 0.1 | B3 | 0.5 | 78 | 430 |
| J7 | B2 | 0.2 | B3 | 0.5 | 75 | 440 |
| J8 | B3 | 0.5 | B3 | 0.5 | 55 | 450 |

As is evident from the results shown in Table 6 above, the battery J1 wherein the cathode plate Bx without addition of a niobium compound was disposed as the cathode plate 11-1 on the respective outer portions of the electrode group, and also as the cathode plate 11-2 in the respective inner portions of the electrode group, a high temperature cycle life considerably deteriorated to 100 cycles. Further, in the case of the battery J2 as well, wherein the cathode plate B3 with addition of 0.5% by mass of a niobium compound was disposed as the cathode plate 11-1 on the respective outer portions of the electrode group, and the cathode plate Bx without addition of a niobium compound was disposed as the cathode plate 11-2 in the respective inner portions of the electrode group, a high temperature cycle life deteriorated to 250 cycles.

In contrast, in the case of the battery J5 wherein the cathode plate B3 with addition of 0.5% by mass of a niobium compound was disposed as the cathode plate 11-2 in the respective inner portions of the electrode group, and the cathode plate Bx without addition of a niobium compound was disposed as the cathode plate 11-1 on the respective outer portions of the electrode group, a high temperature cycle life was considerably enhanced to 410 cycles. This proves that use of the cathode plates B3 with the niobium compound added thereto results in enhancement of high temperature cycle life, however, it would be more effective if the cathode plate B3 with the niobium compound added thereto were to reside in the respective inner portions of the electrode group.

If no niobium compound is added to the cathode plate 11-2 disposed in the respective inner portions of the electrode group, the degradation rate thereof will be higher than that of the cathode plate 11-1 disposed on the respective outer portions (on the sides adjacent to the outer case 15) of the electrode group, where temperature is lower than that in the respective inner portions of the electrode group. This may be explained by the fact that the cathode plate 11-2 disposed in the respective inner portions of the electrode group reached the end of its life sooner than the cathode plate 11-1 disposed on the respective outer portions of the electrode group reached the end of its life, so that the battery as a whole came to have a shorter life.

On the other hand, if a niobium compound is added to the cathode plate 11-2 disposed in the respective inner portions of the electrode group, where temperature rises, degradation occurring to the respective cathode plates 11-2 due to high temperature can be inhibited. As a result, balance in degradation rate can be maintained between the cathode plates 11-2 disposed in the inner portions of the electrode group, respectively, and the cathode plates 11-1 disposed on the outer portions of the electrode group, respectively. Accordingly, it is believed that the high temperature cycle life can be enhanced by disposing the cathode plate B3 with the niobium compound added thereto in the same manner that the cathode plate 11-2 is disposed in the respective inner parts of the electrode group.

Further, in the case of the battery J8 wherein the cathode plate B3 with addition of 0.5% by mass of the niobium compound was disposed as the cathode plate 11-1 on the respective outer sides of the electrode group, and also as the cathode plate 11-2 in the respective inner parts of the electrode groups, the high rate discharge characteristic at room temperature considerably deteriorated by 55% although the high-temperature cycle life was as large as 450 cycles. In contrast, in the case of the battery J7 wherein the cathode plate B3 with addition of 0.5% by mass of the niobium compound was disposed as the cathode plate 11-2 in the respective inner portions of the electrode group, and the cathode plate B2 with an adding amount of the niobium compound, reduced to 0.2% by mass, was disposed as the cathode plate 11-1 on the respective outer portions of the electrode group, the high temperature cycle life was as large as 440 cycles, and the high rate discharge characteristic at room temperature as well was enhanced by 75%.

In the case of the battery J5 wherein the cathode plate B3 with addition of 0.5% by mass of the niobium compound was disposed as the cathode plate 11-2 in the respective inner portions of the electrode group, and the cathode plate Bx without addition of the niobium compound was disposed as the cathode plate 11-1 on the respective outer portions of the electrode group, the high temperature cycle life was as large as 410 cycles, and the high rate discharge characteristic at room temperature was further enhanced by 80%.

It may thus be concluded that with respect to the cathode plate 11-1 disposed on the respective outer sides of the electrode group, increasing the amount of a niobium compound to be added will have an adverse effect on high temperature cycle life, so that the amount of niobium compound to be added to the cathode plate 11-1 disposed on the respective outer sides of the electrode group must be controlled.

Further, with respect to the battery J3 wherein the cathode plate B1 with addition of 0.1% by mass of the niobium compound was disposed as the cathode plate 11-2 in the respective inner portions of the electrode group, and the cathode plate Bx without addition of the niobium compound was disposed as the cathode plate 11-1 on the respective outer portions of the electrode group, the high-temperature cycle life deteriorated to 290 cycles while the high-rate discharge characteristic at room temperature was as high as 80%. In contrast, in the case of the battery J4 wherein the cathode plate B2 with addition of 0.2% by mass of the niobium compound was disposed as the cathode plate 11-2 in the respective inner portions of the electrode group; and the cathode plate Bx without addition of the niobium compound was disposed as the cathode plate 11-1 on the respective outer portions of the electrode group, the high rate discharge characteristic at room temperature was as high as 81% and the high temperature cycle life as well was enhanced to 400 cycles.

This proves that if the amount of niobium compound to be added to the cathode plate 11-2 disposed in the respective inner portions of the electrode group is insufficient, it would not result in the enhancement of high temperature cycle life. Accordingly, the amount of niobium compound to be added to the cathode plate 11-2 disposed in the respective inner portions of the electrode group should preferably be not less than 0.2% by mass. However, if the amount of niobium compound to be added to the cathode plate 11-2 disposed in the respective inner parts of the electrode group is excessively increased, the high rate discharge characteristic at room temperature will deteriorate, and accordingly, the amount to be added should preferably correspond to the minimum required amount, that is, not more than 1.0% by mass according to the results shown Table 2, 8. Studies on Compounds That May Be Added

In the foregoing examples, various cases of adding the niobium compound into the cathode plates are described, however, studies were also made on various cases of adding a titanium compound (for example, TiO₂), tungsten compound (for example, WO₂), and molybdenum compound (for example, MoO₃) to the cathode plates, respectively.

(1) Titanium Compounds

By adding TiO₂ as a titanium compound to the cathode active material (composed mainly of nickel hydroxide coated with a cobalt compound) prepared in the same way as previously described such that the amount of TiO₂ to be added corresponds to 0.1% by mass in relation to the mass of the cathode active material, an active material slurry was prepared, and designated as active material slurry k1. An active material slurry similarly prepared by adding TiO₂ in an amount corresponding to 0.2% by mass was designated as active material slurry k2, and an active material slurry similarly prepared by adding TiO₂ in an amount corresponding to 0.5% by mass was designated as active material slurry k3. In this connection, the titanium compound to be added may be made of a compound selected from the group consisting of Ti₂O₃, TiO, Na₂Ti₃O₇, Li₂TiO₃, K₂TiO₃ and so forth, besides TiO₂.

Thereafter, the active material slurries k1 through k3 were poured into electrode base plates made of porous nickel, respectively, as previously described, and the respective electrode base plates were dried and rolled then cut to a predetermined size, thereby preparing nickel cathode plates K1 through K3 as follows:

(1) nickel cathode plate K1: wherein the active material slurry k1 was used;

(2) nickel cathode plate K2: wherein the active material slurry k2 was used; and

(3) nickel cathode plate K3: wherein the active material slurry k3 was used.

Subsequently, using the nickel cathode plates K1 through K3, respectively, and the hydrogen storage alloy anode plate prepared as previously described, the respective nickel-hydrogen batteries square in shape with a nominal capacity of 900 mAh were prepared in the same way as previously described, as follows:

(1) battery L2: a battery using an electrode group wherein the cathode plate K3 with addition of 0.5% by mass of a titanium compound is disposed as a cathode plate 11-1 on respective outer portions of the electrode group, and the cathode plate Bx without addition of a titanium compound is disposed as a cathode plate 11-2 in respective inner portions of the electrode group;

(2) battery L3: a battery using electrode groups wherein the cathode plate Bx without addition of a titanium compound is disposed as a cathode plate 11-1 on respective outer portions of the electrode group, and the cathode plate K1 with addition of 0.1% by mass of a titanium compound is disposed as a cathode plate 11-2 in respective inner portions of the electrode group;

(3) battery L4: a battery using an electrode group wherein the cathode plate Bx without addition of a titanium compound is disposed as a cathode plate 11-1 on respective outer portions of the electrode group, and the cathode plate K2 with addition of 0.2% by mass of a titanium compound is disposed as a cathode plate 11-2 in respective inner portions of the electrode groups;

(4) battery L5: a battery using an electrode group wherein the cathode plate Bx without addition of a titanium compound is disposed as a cathode plate 11-1 on respective outer portions of the electrode group, and the cathode plate K3 with addition of 0.5% by mass of a titanium compound is disposed as a cathode plate 11-2 in respective inner portions of the electrode groups;

(5) battery L6: a battery using an electrode group wherein the cathode plate K1 with addition of 0.1% by mass of a titanium compound is disposed as a cathode plate 11-1 on respective outer portions of the electrode group, and the cathode plate K3 with addition of 0.5% by mass of a titanium compound is disposed as a cathode plate 11-2 in respective inner portions of the electrode groups;

(6) battery L7: a battery using an electrode group wherein the cathode plate K2 with addition of 0.2% by mass of a titanium compound is disposed as a cathode plate 11-1 on respective outer portions of the electrode group, and the cathode plate K3 with addition of 0.5% by mass of a titanium compound is disposed as a cathode plate 11-2 in respective inner portions of the electrode group; and

(7) battery L8: a battery using an electrode group wherein the cathode plate K3 with addition of 0.5% by mass of a titanium compound is disposed as a cathode plate 11-1 on respective outer portions of the electrode group, and the cathode plate K3 with addition of 0.5% by mass of a titanium compound is also disposed as a cathode plate 11-2 in respective inner portions of the electrode group.

(Test 7)

Thereafter, using the batteries, L2 through L8, fabricated in the manner described above, a battery with a high rate discharge characteristic at room temperature and a high temperature cycle life (capacity-maintaining ratio) was found. The test results obtained as well as the results concerning the battery J1 previously described are shown in Table 7 below.

TABLE 7

| | | | | | high rate | High |
|---|---|---|---|---|---|---|
| | nickel cathode | | nickel cathode | | discharge | temp. |
| | (outer) | | (inner) | | at room | cycle |
| battery | | add. amount | | add. Amount | temp. | life |
| type | type | (% by mass) | type | (% by mass) | (%) | (times) |
| J1 | Bx | no addition | Bx | no addition | 82 | 100 |
| L2 | K3 | 0.5 | Bx | no addition | 79 | 230 |
| L3 | Bx | no addition | K1 | 0.1 | 80 | 270 |
| L4 | Bx | no addition | K2 | 0.2 | 80 | 390 |
| L5 | Bx | no addition | K3 | 0.5 | 79 | 410 |
| L6 | K1 | 0.1 | K3 | 0.5 | 78 | 410 |
| L7 | K2 | 0.2 | K3 | 0.5 | 74 | 420 |
| L8 | K3 | 0.5 | K3 | 0.5 | 57 | 430 |

As can be derived from the above, the results shown in Table 7 above are substantially similar to the results shown in Table 6. Accordingly, it may be concluded that the high temperature cycle life can also be enhanced by using a cathode plate with a titanium compound added thereto. To maximize effectivity, however, the cathode plates with the titanium compound added thereto should be disposed in the respective inner portions of the electrode group. In such a case, with respect to the cathode plate 11-1 disposed on the respective outer portions of the electrode group, increasing the amount of the titanium compound to be added has an adverse effect on the high temperature cycle life, and accordingly should be controlled. As in the previously described case of the niobium compound, the amount of titanium compound to be added should be not more than 1.0% by mass.

Further, since no advantage is achieved by way of enhancing the high temperature cycle life if the amount of titanium compound to be added to the cathode plate 11-2 disposed in the respective inner parts of the electrode group is insufficient, such amount to be added should preferably be not less than 0.2% by mass. However, it must be noted that if the amount of titanium compound added to the cathode plate 11-2 disposed in the respective inner parts of the electrode group is excessively increased, the high rate discharge characteristic of the battery at room temperature will deteriorate. Accordingly, the amount of titanium compound to be added to the cathode plate 11-2 disposed in the respective inner parts of the electrode group should preferably correspond to the minimum required amount for maintaining a satisfactory cycle life, that is, not more than 1.0% by mass.

(2) Tungsten Compounds

By adding WO₂ as a tungsten compound to the cathode active material (composed mainly of nickel hydroxide coated with a cobalt compound) prepared in the same way as previously described such that the amount of WO₂ to be added corresponds to 0.1% by mass in relation to the mass of the cathode active material, an active material slurry was prepared, and designated as active material slurry m1. An active material slurry similarly prepared by adding WO₂ in an amount corresponding to 0.2% by mass was designated as active material slurry m2, and an active material slurry similarly prepared by adding WO₂ in an amount corresponding to 0.5% by mass was designated as active material slurry m3. Further, the tungsten compound to be added to the cathode active material may be made of a compound selected from the group consisting of WO₃, Na₂WO₄, Li₂WO₂, K₂WO₄ and so forth, besides WO₂.

Thereafter, the active material slurries m1 through m3 were poured into electrode base plates made of porous nickel, as previously described, respectively, and the respective electrode base plates were dried and rolled then cut to a predetermined size, thereby preparing nickel cathode plates M1 through M3 as follows:

(1) nickel cathode plate M1: wherein the active material slurry m1 was used;

(2) nickel cathode plate M2: wherein the active material slurry m2 was used; and

(3) nickel cathode plate M3: wherein the active material slurry m3 was used.

Subsequently, using the nickel cathode plates M1 through M3, respectively, and the hydrogen storage alloy anode plate prepared as previously described, nickel-hydrogen batteries, N2 through N8, square in shape, with a nominal capacity of 900 mAh, were prepared in the same way as previously described, as follows:

(1) battery N2: a battery using an electrode group wherein the cathode plate M3 with addition of 0.5% by mass of a tungsten compound is disposed as a cathode plate 11-1 on respective outer portions of the electrode group, and the cathode plate Bx without addition of the tungsten compound is disposed as a cathode plate 11-2 in respective inner portions of the electrode group;

(2) battery N3: a battery using an electrode group wherein the cathode plate Bx without addition of a tungsten compound is disposed as a cathode plate 11-1 on respective outer portions of the electrode group, and the cathode plate M1 with addition of 0.1% by mass of the tungsten compound is disposed as a cathode plate 11-2 in respective inner portions of the electrode group;

(3) battery N4: a battery using an electrode group wherein the cathode plate Bx without addition of a tungsten compound is disposed as a cathode plate 11-1 on respective outer portions of the electrode group, and the cathode plate M2 with addition of 0.2% by mass of the tungsten compound is disposed as a cathode plate 11-2 in respective inner portions of the electrode group;

(4) battery N5: a battery using an electrode group wherein the cathode plate Bx without addition of a tungsten compound is disposed as a cathode plate 11-1 on respective outer portions of the electrode group, and the cathode plate M3 with addition of 0.5% by mass of the tungsten compound is disposed as a cathode plate 11-2 in respective inner portions of the electrode group;

(5) battery N6: a battery using an electrode group wherein the cathode plate M1 with addition of 0.1% by mass of a tungsten compound is disposed as a cathode plate 11-1 on respective outer portions of the electrode group, and the cathode plate M3 with addition of 0.5% by mass of the tungsten compound is disposed as a cathode plate 11-2 in respective inner portions of the electrode group;

(6) battery N7: a battery using an electrode group wherein the cathode plate M2 with addition of 0.2% by mass of a tungsten compound is disposed as a cathode plate 11-1 on respective outer portions of the electrode group, and the cathode plate M3 with addition of 0.5% by mass of the tungsten compound is disposed as a cathode plate 11-2 in respective inner portions of the electrode group; and

(7) battery N8: a battery using an electrode group wherein the cathode plate M3 with addition of 0.5% by mass of a tungsten compound is disposed as a cathode plate 11-1 on respective outer portions of the electrode group, and the cathode plate M3 with addition of 0.5% by mass of a tungsten compound is also disposed as a cathode plate 11-2 in respective inner portions of the electrode group.

(Test 8)

Thereafter, using the batteries, N2 through N8, fabricated in the manner described above, respectively, an alkaline storage battery with high rate discharge characteristic at room temperature and a high temperature cycle life (capacity-maintaining ratio) was found. The test results obtained as well as the results concerning the battery J1 previously described are shown in Table 8 below.

TABLE 8

| | | | | | high rate | high |
|---|---|---|---|---|---|---|
| | nickel cathode | | nickel cathode | | discharge | temp. |
| | (outer) | | (inner) | | at room | cycle |
| Battery | | add. amount | | add. Amount | temp. | life |
| type | type | (% by mass) | type | (% by mass) | (%) | (times) |
| J1 | Bx | no addition | Bx | no addition | 82 | 100 |
| N2 | M3 | 0.5 | Bx | no addition | 80 | 200 |
| N3 | Bx | no addition | M1 | 0.1 | 81 | 270 |
| N4 | Bx | no addition | M2 | 0.2 | 80 | 390 |
| N5 | Bx | no addition | M3 | 0.5 | 79 | 410 |
| N6 | M1 | 0.1 | M3 | 0.5 | 78 | 430 |
| N7 | M2 | 0.2 | M3 | 0.5 | 75 | 430 |
| N8 | M3 | 0.5 | M3 | 0.5 | 51 | 430 |

As can be derived from the above, the results shown in Table 8 above are substantially similar to the results shown in Tables 6 and 7.

Accordingly, it may be concluded that the high temperature cycle life can also be enhanced by using a cathode plate with a tungsten compound added thereto. To maximize effectivity, however, the cathode plates with the tungsten compound added thereto should be disposed in the respective inner portions of the electrode group. In such a case, with respect to the cathode plate 11-1 disposed on the respective outer portions of the electrode group, increasing the amount of the tungsten compound to be added has an adverse effect on the high temperature cycle life, and accordingly should be controlled. As in the previously described case of the niobium compound, the amount of titanium compound to be added should be not more than 1.0% by mass.

Further, since no advantage is achieved by way of enhancing the high temperature cycle life if the amount of tungsten compound to be added to the cathode plate 11-2 disposed in the respective inner parts of the electrode group is insufficient, such amount to be added should preferably be not less than 0.2% by mass. However, it must be noted that if the amount of tungsten compound added to the cathode plate 11-2 disposed in the respective inner parts of the electrode group is excessively increased, the high rate discharge characteristic of the battery at room temperature will deteriorate. Accordingly, the amount of tungsten compound to be added to the cathode plate 11-2 disposed in the respective inner parts of the electrode group should preferably correspond to the minimum required amount for maintaining a satisfactory cycle life, that is, not more than 1.0% by mass.

(3) Molybdenum Compounds

By adding MoO₃as a molybdenum compound to the cathode active material (composed mainly of nickel hydroxide coated with a cobalt compound) prepared in the same way as previously described such that the amount of MoO₃ to be added corresponds to 0.1% by mass in relation to the mass of the cathode active material, an active material slurry was prepared, and designated as an active material slurry p1. An active material slurry similarly prepared by adding MoO₃ in an amount corresponding to 0.2% by mass was designated as active material slurry p2, and an active material slurry similarly prepared by adding MoO₃ in an amount corresponding to 0.5% by mass was designated as active material slurry p3. In this connection, the molybdenum compound to be added may be made of a molybdenum compound selected from the group consisting of MoO₃.H₂O, MoO₃.2H₂O, Na₂MoO₄.2H₂O, Li₆Mo₇O₂₄.12H₂O, K₂MoO₄ and so forth, besides MoO₃.

Thereafter, the active material slurries p1 through p3 were poured into electrode base plates made of porous nickel as previously described, respectively, and the respective electrode base plates were dried and rolled then cut to a predetermined size, thereby preparing nickel cathode plates P1 through P3 as follows:

(1) nickel cathode plate P1: wherein the active material slurry p1 was used;

(2) nickel cathode plate P2: wherein the active material slurry p2 was used; and

(3) nickel cathode plate P3: wherein the active material slurry p3 was used.

Subsequently, using the nickel cathode plates P1 through P3, respectively, and the hydrogen storage alloy anode plate prepared as previously described, respective nickel-hydrogen batteries, O2 through Q8, square in shape, with a nominal capacity of 900 mAh, were prepared in the same way as previously described, as follows:

(1) battery O2: a battery using an electrode group wherein the cathode plate P3 with addition of 0.5% by mass of a molybdenum compound is disposed as a cathode plate 11-1 on respective outer portions of the electrode group, and the cathode plate Bx without addition of the molybdenum compound is disposed as a cathode plate 11-2 in respective inner portions of the electrode group;

(2) battery Q3: a battery using an electrode group wherein the cathode plate Bx without addition of a molybdenum compound is disposed as a cathode plate 11-1 on respective outer portions of the electrode group and the cathode plate P1 with addition of 0.1% by mass of the molybdenum compound is disposed as a cathode plate 11-2 in respective inner portions of the electrode group;

(3) battery Q4: a battery using an electrode group wherein the cathode plate Bx without addition of a molybdenum compound is disposed as a cathode plate 11-1 on respective outer portions of the electrode group and the cathode plate P2 with addition of 0.2% by mass of the molybdenum compound is disposed as a cathode plate 11-2 in respective inner portions of the electrode group;

(4) battery Q5: a battery using an electrode group wherein the cathode plate Bx without addition of a molybdenum compound is disposed as a cathode plate 11-1 on respective outer portions of the electrode group and the cathode plate P3 with addition of 0.5% by mass of the molybdenum compound is disposed as a cathode plate 11-2 in respective inner portions of the electrode group;

(5) battery Q6: a battery using an electrode group wherein the cathode plate P1 with addition of 0.1% by mass of a molybdenum compound is disposed as a cathode plate 11-1 on respective outer portions of the electrode group and the cathode plate P3 with addition of 0.5% by mass of the molybdenum compound is disposed as a cathode plate 11-2 in respective inner portions of the electrode group;

(6) battery Q7: a battery using an electrode group wherein the cathode plate P2 with addition of 0.2% by mass of a molybdenum compound is disposed as a cathode plate 11-1 on respective outer portions of the electrode group and the cathode plate P3 with addition of 0.5% by mass of the molybdenum compound is disposed as a cathode plate 11-2 in respective inner portions of the electrode group; and

(7) battery Q8: a battery using an electrode group wherein the cathode plate P3 with addition of 0.5% by mass of a molybdenum compound is disposed as a cathode plate 11-1 on respective outer portions of the electrode group and the cathode plate P3 with addition of 0.5% by mass of a molybdenum compound is also disposed as a cathode plate 11-2 in respective inner portions of the electrode group.

(Test 9)

Thereafter, using the batteries, Q2 through Q8, fabricated in the manner described above, a battery with a high rate discharge characteristic at room temperature and a high temperature cycle life (capacity-maintaining ratio) was found, The test results obtained as well as the results concerning the battery J1 previously described are also shown in Table 9 below.

TABLE 9

| | | | | | high rate | high |
|---|---|---|---|---|---|---|
| | nickel cathode | | nickel cathode | | discharge | temp. |
| | (outer) | | (inner) | | at room | cycle |
| battery | | add. amount | | add. Amount | temp. | life |
| type | type | (% by mass) | type | (% by mass) | (%) | (times) |
| J1 | Bx | no addition | Bx | no addition | 82 | 100 |
| Q2 | P3 | 0.5 | Bx | no addition | 78 | 190 |
| Q3 | Bx | no addition | P1 | 0.1 | 81 | 280 |
| Q4 | Bx | no addition | P2 | 0.2 | 79 | 400 |
| Q5 | Bx | no addition | P3 | 0.5 | 79 | 420 |
| Q6 | P1 | 0.1 | P3 | 0.5 | 78 | 430 |
| Q7 | P2 | 0.2 | P3 | 0.5 | 74 | 440 |
| Q8 | P3 | 0.5 | P3 | 0.5 | 49 | 440 |

As can be derived from the above, the results shown in Table 9 above are substantially similar to the results shown in Tables 6, 7 and 8. Accordingly, it may be concluded that the high temperature cycle life can also be enhanced by using a cathode plate with a molybdenum compound added thereto. To maximize effectivity, however, the cathode plates with the molybdenum compound added thereto should be disposed in the respective inner portions of the electrode group. In such a case, with respect to the cathode plate 11-1 disposed on the respective outer portions of the electrode group, increasing the amount of the molybdenum compound to be added has an adverse effect on the high temperature cycle life, and accordingly should be controlled. As in the previously described case of the niobium compound, the amount of molybdenum compound to be added should be not more than 1.0% by mass.

Further, since no advantage is achieved by way of enhancing the high temperature cycle life if the amount of molybdenum compound to be added to the cathode plate 11-2 disposed in the respective inner portions of the electrode group is insufficient, such amount to be added should preferably be not less than 0.2% by mass. However, it must be noted that if the amount of molybdenum compound added to the cathode plate 11-2 disposed in the respective inner portions of the electrode group is excessively increased, the high rate discharge characteristic of the battery at room temperature will deteriorate. Accordingly, the amount of molybdenum compound to be added to the cathode plate 11-2 disposed in the respective inner portions of the electrode group should preferably correspond to the minimum required amount for maintaining a satisfactory cycle life, that is, not more than 1.0% by mass.

In the foregoing examples embodying the invention cases where the amount of at least one species of a compound selected from the group consisting of niobium compound, titanium compound, tungsten compound, and molybdenum compound to be added to the cathode plate 11-1 disposed on the respective outer portions of the electrode group is decreased while increasing the amount of any of the aforementioned compounds to be added to the cathode plate 11-2 disposed in the respective inner portions of the electrode group have been described. However, where an electrode group comprising a large number of cathode plates disposed therein is to be used, the electrode group may be configured such that the cathode plates are disposed in such a way as to allow the addition of those compounds to increase in sequence from the outer portion of the electrode group toward the inner portion thereof.

Further, the foregoing examples have illustrated cases of fabricating an alkaline storage battery using the electrode group formed by disposing the cathode plates 11 in flat plate shape and the anode plates 12 in flat plate shape so as to oppose each other with the separator 13 interposed therebetween, and laminating the cathode plates 11 in flat plate shape to the anode plates 12 in flat plate shape, respectively.

However, the invention is not limited to those cases, and can in fact be applied to a battery cylindrical in shape, fabricated by using a spiral electrode group formed by disposing a cathode plate in webbing-like shape and an anode plate in webbing-like shape in such manner as to oppose each other with a separator interposed therebetween, and winding about both plates in spiral form before inserting the spiral electrode group into an outer case cylindrical in shape. In this case, fabrication is to be particularly implemented such that the cathode plates each having different amounts of at least one species of a compound selected from the group consisting of niobium compound, titanium compound, tungsten compound, and molybdenum compound shall be bonded together, such that one cathode plate in webbing-like shape is formed, and an electrode group subsequently formed by winding about in spiral form the cathode plate in webbing-like shape together with a hydrogen storage alloy anode plate prepared in webbing-like shape, with the separator interposed therebetween, is inserted into the outer case cylindrical in shape.

As described hereinbefore, under the invention, at least one species of a compound selected from the group consisting of niobium compound, titanium compound, tungsten compound, and molybdenum compound is introduced into the nickel cathodes provided with the cathode active material composed mainly of nickel hydroxide which surface has a coating layer of cobalt compound. Accordingly, the rate at which the cobalt compound coating the surface of the active material layer composed mainly of the nickel hydroxide is dissolved and precipitated in the alkaline electrolytic solution can decrease and the layer of the cobalt compound can become to turn denser in structure, thereby enabling the electrically conductive network to be improved. Further, since not less than 0.6 mol/L of lithium hydroxide is contained in the alkaline electrolytic solution, it becomes possible to inhibit dissolution of the niobium compound, titanium compound, tungsten compound, or molybdenum compound in the alkaline electrolytic solution. This will enable an excellent electrically conductive network to be maintained.

Still further, with the invention, since the amount of at least one species of a compound selected from the group consisting of niobium compound, titanium compound, tungsten compound, and molybdenum compound to be added is modified such that the amount to be added increases as the cathode is further located in the respective inner parts of the electrode group, the life cycle of the cathode disposed in the respective inner parts of the electrode group is greatly enhanced, regardless of an increase in temperature of the battery. As a result, this will lead to enhancement of the life cycle of the battery as a whole.

What is claimed is:

1. An alkaline storage battery comprising nickel cathodes and an alkaline electrolytic solution, wherein at least one species of a compound selected from the group consisting of niobium compound, titanium compound, tungsten compound and molybdenum compound is introduced into the nickel cathodes comprising a cathode active material composed mainly of nickel hydroxide, which surface has a coating layer of a cobalt compound, and the alkaline electrolytic solution contains lithium hydroxide, a lithium hydroxide content being not less than 0.6 mol/L and not more than 1.6 mol/L.

2. An alkaline storage battery according to claim 1, wherein the cobalt compound is a cobalt compound containing alkaline cations.

3. An alkaline storage battery according to claim 1, wherein the amount of at least one species of a compound selected from the group consisting of niobium compound, titanium compound, tungsten compound and molybdenum compound to be added is not less than 0.2% by mass and not more than 1.0% by mass in relation to the mass of the cathode active material composed mainly of nickel hydroxide, having the coating layer of the cobalt compound.

4. An alkaline storage battery according to claim 1, wherein the alkaline electrolytic solution contains sodium hydroxide.

5. An alkaline storage battery incorporating an electrode group comprising nickel cathodes and anodes, disposed in such a way as to oppose each other with a separator interposed therebetween, wherein the nickel cathodes each include a cathode active material composed mainly of nickel hydroxide, having a coating layer of a cobalt compound, and to which at least one species of a compound selected from the group consisting of a niobium compound, titanium compound, tungsten compound and molybdenum compound is added while the amount of at least one species of a compound selected from the group consisting of niobium compound, titanium compound, tungsten compound and molybdenum compound for each of the nickel cathodes disposed in inner parts of the electrode group is greater than that for each of the nickel cathodes disposed on the outer sides of the electrode group.

6. An alkaline storage battery according to claim 5, wherein at least one species of a compound selected from the group consisting of niobium compound, titanium compound, tungsten compound and molybdenum compound is introduced into each of the nickel cathodes such that the amount of at least one species of a compound for each of the nickel cathodes increases in sequence from the outer portion of the electrode group toward the inner portion thereof.

7. An alkaline storage battery according to claim 5, wherein the cobalt compound coating the nickel hydroxide is a cobalt compound containing alkaline cations.

8. An alkaline storage battery according to claim 5, wherein the amount of at least one species of a compound selected from the group consisting of niobium compound, titanium compound, tungsten compound and molybdenum compound, to be added to each of the nickel cathodes disposed in the inner parts of the electrode group, is not less than 0.2% by mass and not more than 1.0% by mass in relation to the mass of the cathode active material composed mainly of the nickel hydroxide, having a layer of coating of cobalt compound.

9. An alkaline storage battery incorporating an electrode group comprising nickel cathodes and anodes, disposed in such a way as to oppose each other with a separator interposed therebetween, and an alkaline electrolytic solution, wherein the nickel cathodes each include cathode active material composed mainly of nickel hydroxide, having a layer of coating of cobalt compound, and to which at least one species of a compound selected from the group consisting of niobium compound, titanium compound, tungsten compound and molybdenum compound is added while the amount of at least one species of a compound selected from the group consisting of niobium compound, titanium compound, tungsten compound and molybdenum compound to be added to each of the nickel cathodes disposed in the inner portions of the electrode group is greater than that for each of the nickel cathodes disposed on the outer portions of the electrode group, and the alkaline electrolytic solution contains lithium hydroxide of not less than 0.6 mol/L and not more than 1.6 mol/L.

10. An alkaline storage battery according to claim 9, wherein at least one species of a compound selected from the group consisting of niobium compound, titanium compound, tungsten compound and molybdenum compound is introduced into each of the nickel cathodes such that the amount of at least one species of a compound for each of the nickel cathodes increases in sequence from the outer portions of the electrode group toward the inner portions thereof.

11. An alkaline storage battery according to claim 9, wherein the cobalt compound coating the nickel hydroxide is a cobalt compound containing alkaline cations.

12. An alkaline storage battery according to claim 9 or 10, wherein the amount of at least one species of a compound selected from the group consisting of niobium compound, titanium compound, tungsten compound and molybdenum compound, to be added to each of the nickel cathodes disposed in inner parts of the electrode group, is not less than 0.2% by mass and not more than 1.0% by mass in relation to the mass of the cathode active material composed mainly of the nickel hydroxide, having a layer of coating of cobalt compound.

13. An alkaline storage battery according to claim 9, wherein the alkaline electrolytic solution contains sodium hydroxide.
